(19) United States
(12) Patent Application Publication
(10) Pub. No.: US 2025/0183593 A1
(43) Pub. Date: Jun. 5, 2025

(54) HIGH DENSITY, HIGH SPEED, HIGH PERFORMANCE CARD EDGE CONNECTOR

(71) Applicant: Amphenol Commercial Products (Chengdu) Co., Ltd., Chengdu (CN)

(72) Inventors: Kui Yang, Chengdu (CN); Xiaodong Hu, Chengdu (CN)

(73) Assignee: Amphenol Commercial Products (Chengdu) Co., Ltd., Chengdu (CN)

(21) Appl. No.: 18/967,574

(22) Filed: Dec. 3, 2024

(30) Foreign Application Priority Data
Dec. 5, 2023 (CN) 202311660045.7
Dec. 5, 2023 (CN) 202323300834.8

(51) Int. Cl. H01R 13/6471; H01R 12/71; H01R 13/05; H01R 13/502

(52) U.S. Cl. CPC H01R 13/6471; H01R 12/716; H01R 13/055; H01R 13/502

(57) ABSTRACT

A connector for high density, high speed, and high performance electronic systems. The connector has a housing with a mating face and holding one or more rows of terminals. The connector has a first conductive member with a planar body. A broadside of the planar body faces the mating face of the housing. The connector can have a second conductive member with a planar body extending orthogonally to the planar body of the first conductive member. The first and second conductive members are coupled to intermediate portions of ground terminals in a same row from opposite sides. The first and second conductive members can operate in synergy to improve signal integrity performances in connectors designed for 64 Gbps and beyond, while conforming to a standard that constrains mating and mounting interfaces.

### CROSS-REFERENCE TO RELATED APPLICATIONS

This application claims priority to and the benefit of Chinese Patent Application No. 202323300834.8, filed on Dec. 5, 2023. This application also claims priority to and the benefit of Chinese Patent Application No. 202311660045.7, filed on Dec. 5, 2023. The contents of these applications are incorporated herein by reference in their entirety.

### TECHNICAL FIELD

This application relates generally to electrical interconnection systems, such as those including electrical connectors, used to interconnect electronic assemblies.

### BACKGROUND

Electrical connectors are used in many electronic systems. It is generally easier and more cost-effective to manufacture a system as separate electronic subassemblies, such as printed circuit boards (PCBs), which may be joined together by electrical connectors. Having separable electrical connectors enables components of the electronic system manufactured by different manufacturers to be readily assembled. Separable electrical connectors also enable components to be readily replaced after the system is assembled, either to replace defective components or to upgrade the system with higher-performance components.

For example, this configuration is often used in computer devices in which a PCB called “a motherboard” might have a processor and a bus configured to transmit data between the processor and peripherals, such as a memory card or graphics processor. Electrical connectors may be mounted to the motherboard and connected to the bus. The peripherals may be implemented on one or more PCBs (called “daughter cards”). The daughter cards may mate directly with the electrical connectors on the bus, or the daughter cards may include additional electrical connectors that may mate with the electrical connectors on the bus, thereby connecting to the bus. In this way, separately manufactured peripherals may be readily integrated onto the motherboard.

To enhance the availability of peripherals, the bus and the connectors used to physically connect peripherals via the bus may be standardized. In this way, there may be a large number of peripherals available from a multitude of manufacturers. All of those products, so long as they are compliant with the standards, may be used in a computer device that has a bus compliant with the standards. Examples of such standards include DDR standards such as DDR4 or DDR5, serial ATA (SATA), serial attached SCSI (SAS), or peripheral component interconnect express (PCIe). The standards have gone through multiple revisions over time, adapting to the higher performance requirements on computer devices.

### BRIEF SUMMARY

Aspects of the present disclosure relate to high density, high speed, and high performance card edge connectors.

Some embodiments relate to an electrical connector. The electrical connector may include a housing comprising a mating face, a mounting face, and a slot recessed from the mating face; a plurality of conductive elements held by the housing in first and second rows separated by the slot, each of the plurality of conductive elements comprising a mating end curving into the slot, a tail end extending out of the housing at the mounting face, and an intermediate portion between the mating end and the tail end, each of the first and second rows comprising signal terminals and ground terminals disposed between the signal terminals; and a conductive member electrically coupling the ground terminals in the first and second rows of conductive elements, the conductive member comprising a planar body disposed between the first and second rows of conductive elements, the planar body having: a first edge facing the first row of conductive elements, a second edge facing the second row of conductive elements, and a broadside facing the mating face and joining the first and second edges.

Optionally, the conductive member is configured to reduce both insertion loss and return loss for the electrical connector.

Optionally, the planar body of the conductive member is disposed adjacent the mounting face of the housing.

Optionally, the conductive member comprises: a plurality of first beams extending from the first edge of the planar body towards respective ground terminals in the first row; and a plurality of second beams extending from the second edge of the planar body towards respective ground terminals in the second row.

Optionally, the slot is elongated in a first direction; and the plurality of first beams and the plurality of second beams are offset from each other in the first direction.

Optionally, each of the plurality of first beams comprises: a first subportion extending from the first edge of the planar body in a direction perpendicular to the planar body; and a second subportion extending from the first subportion away from the first edge towards the respective ground terminal in the first row and configured to contact the intermediate portion of the respective ground terminal in the first row.

Optionally, the housing comprises a plurality of first channels recessed into the housing from the mounting face in the direction perpendicular to the planar body; and each of the plurality of first beams is disposed in a respective one of the plurality of first channels.

Optionally, each of the plurality of first channels comprises a first sidewall and a second sidewall opposite to each other, and a first groove and a second groove recessed into the housing from the first sidewall and the second sidewall, respectively; and for each of the plurality of first beams, the first subportion comprises a first side edge and a second side edge opposite to each other, the first side edge and the second side edge of the first subportion are received in the first groove and the second groove of the respective first channel, respectively.

Optionally, for each of the plurality of first beams: the first subportion further comprises a first barb and a second barb protruding from the first side edge and the second side edge, respectively, and the first barb and the second barb engage with a bottom wall of the first groove and a bottom wall of the second groove of the respective first channel, respectively.

Optionally, each of the plurality of first channels comprises a third sidewall and a fourth sidewall opposite to each other; the third sidewall comprises an opening connected to the intermediate portion of the respective ground terminal; and the first subportion of each of the plurality of first beams and the second beam is disposed against the fourth sidewall of the respective first channel.

Optionally, the conductive member is a first conductive member; the electrical connector further comprises a second conductive member disposed in the housing, the second conductive member separated from the first row by the first conductive member; and the second conductive member electrically couples the ground terminals in the first row.

Optionally, the second conductive member comprises: a planar body orthogonal to the planar body of the first conductive member; and a plurality of beams extending from the planar body towards respective ground terminals in the first row.

Optionally, for the second conductive member: each of the plurality of beams comprises a connecting subportion and a contact subportion; the connecting subportion extends from an edge of the planar body towards a respective ground terminal in the first row; and the contact subportion extends from the connecting subportion and configured to contact the intermediate portion of the respective ground terminal in the first row.

Optionally, for each ground terminal in the first row: the first conductive member and the second conductive member contact a same subportion of the intermediate portion of the respective ground terminal in the first row from opposite sides.

Some embodiments relate to an electrical connector. The electrical connector may include a housing comprising a mating face, a mounting face, and a slot recessed from the mating face; a plurality of conductive elements held by the housing in first and second rows separated by the slot, each of the plurality of conductive elements comprising a mating end curving into the slot, a tail end extending out of the mounting face, and an intermediate portion between the mating end and the tail end, the plurality of conductive elements disposed in the housing, with the tail ends at least partially located outside of the housing; and a conductive member separated from the slot by the first row of conductive element, the conductive member comprising: a planar body disposed in the housing and orthogonal to the mating face, and a plurality of beams extending from the planar body and coupled to the intermediate portions of a subset of the plurality of conductive elements in the first row.

Optionally, the planar body of the conductive member extends in parallel to the first row of conductive element; and each of the plurality of beams comprises: a first subportion extending from a bottom edge of the planar body towards a respective conductive element of the subset of the plurality of conductive elements in the first row, and a second subportion extending from the first subportion and parallel to a subportion of the intermediate portion of the respective conductive element in the first row.

Optionally, the housing comprises an elongated groove spaced from the mounting face and a plurality of channels connected to the groove; the subportion of the intermediate portion of each conductive element of the subset of the plurality of conductive elements in the first row is disposed in a respective one of the plurality of channels; the planar body of the conductive member disposed in the elongated groove; and each of the plurality of beams of the conductive member is disposed in a respective one of the plurality of channels.

Some embodiments relate to an electrical connector. The electrical connector may include a plurality of conductive elements disposed in a row, each of the plurality of conductive elements comprising a mating end having a mating contact portion, a tail end configured to mount to a contact pad on a surface of a circuit board, and an intermediate portion between the mating end and the tail end; a first conductive member disposed on a first side of the row, the first conductive member comprising a plurality of first beams configured to contact the intermediate portion of selected ones of the plurality of conductive elements from the first side; and a second conductive member disposed on a second side of the row opposite the first side, the second conductive member comprising a plurality of second beams configured to contact the intermediate portions of the selected ones of the plurality of conductive elements from the second side.

Optionally, each of the first and second conductive members comprises a planar body; and the planar body of the first and second conductive members extending orthogonally to each other.

Optionally, the first conductive member comprises a plurality of beams configured to press against the intermediate portions of the respective ones of the selected conductive elements; and the second conductive member comprises a plurality of beams configured to be welded to the intermediate portions of the respective ones of the selected conductive elements.

Some embodiments relate to an electrical connector. The electrical connector may comprise: an insulative housing comprising a mating face and a slot recessed into the insulative housing from the mating face in a vertical direction, the slot elongated in a longitudinal direction perpendicular to the vertical direction; a plurality of conductive elements each comprising a mating end, a tail end opposite to the mating end, and an intermediate portion extending between the mating end and the tail end, the plurality of conductive elements disposed in the insulative housing and arranged in a first row and a second row each extending in the longitudinal direction, mutually opposed and spaced apart from each other across the slot, with the mating ends exposed in the slot and the tail ends at least partially located outside of the insulative housing, each of the first row and the second row comprising a signal terminal and a ground terminal; and a first conductive member mounted to the insulative housing between the first row and the second row. The first conductive member may comprise: a first body in a shape of a flat strip and extending in a first main plane perpendicular to the vertical direction; and a plurality of first extensions each extending from the first body towards a corresponding ground terminal of the first row and the second row and electrically coupled to the intermediate portion of the corresponding ground terminal, such that the first conductive member electrically couples the ground terminals of the first row and the second row together.

Some embodiments relate to an electrical connector configured to be mounted to a circuit board. The electrical connector may comprise: an insulative housing; a plurality of conductive elements each comprising a mating end, a tail end opposite to the mating end, and an intermediate portion extending between the mating end and the tail end, the plurality of conductive elements disposed in the insulative housing, with the tail ends at least partially located outside of the insulative housing, each tail end configured to be attached with a solder ball and to be connected to a corresponding conductive pad on the circuit board by using the solder ball when the electric connector is mounted to the circuit board, the plurality of conductive elements arranged in a first row and a second row each extending in a longitudinal direction, mutually opposed and spaced apart from each other, each of the first row and the second row comprising a signal terminal and a plurality of ground terminals; and a conductive member disposed in the insulative housing at a side of the first row facing away from the second row in a lateral direction perpendicular to the longitudinal direction and configured for electrically coupling the plurality of ground terminals of the first row together by electrically coupling with the intermediate portions of the plurality of ground terminals of the first row.

Some embodiments relate to an electrical connector. The electrical connector may comprise: an insulative housing; a plurality of conductive elements comprising a signal terminal and a plurality of ground terminals, each of the plurality of conductive elements comprising a mating end, a tail end opposite to the mating end, and an intermediate portion extending between the mating end and the tail end, the plurality of conductive elements disposed in a row in the insulative housing, the row extending in a longitudinal direction and comprising a first side and a second side opposite to each other in a lateral direction perpendicular to the longitudinal direction, each intermediate portion comprising a first surface and a second surface opposite to each other in the lateral direction; and a first conductive member mounted to the insulative housing at the first side of the row, and comprising a plurality of first beams; and a second conductive member disposed in the insulative housing at the second side of the row, and comprising a plurality of second beams; for each ground terminal, a corresponding one of the plurality of first beams contacts with the intermediate portion of the ground terminal on the first surface of the intermediate portion, and a corresponding one of the plurality of second beams contacts with the intermediate portion of the ground terminal on the second surface of the intermediate portion.

Some embodiments relate to an electrical connector. The electrical connector may comprise: an insulative housing comprising a mounting face and a plurality of channels recessed into the insulative housing from the mounting face in a vertical direction; a plurality of conductive elements each comprising a mating end, a mounting end opposite to the mating end, and an intermediate portion extending between the mating end and the mounting end, the plurality of conductive elements disposed in the insulative housing and extending out of the insulative housing from the mounting face, with the mounting ends at least partially located outside of the insulative housing, the plurality of conductive elements arranged in a first row and a second row each extending in a longitudinal direction perpendicular to the vertical direction, mutually opposed and spaced apart from each other, each of the first row and the second row comprising a signal terminal and a ground terminal, the intermediate portion of each of the ground terminals of the first row and the second row exposed in a corresponding one of the plurality of channels; and a conductive member mounted to the insulative housing between the first row and the second row and comprising a body elongated in the longitudinal direction, and a first beam and a second beam extending from the body, wherein the body is disposed on the mounting face and wherein each of the first beam and the second beam is received in a corresponding one of the plurality of channels and is resiliently pressed against the intermediate portion of a corresponding ground terminal exposed in the corresponding channel.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electronic system including a circuit board and an electrical connector, according to some embodiments.

FIG. 1B is an exploded perspective view of the electronic system of FIG. 1A.

FIG. 1C is an enlarged view of the region 1C marked by the dashed box in FIG. 1A.

FIG. 1D is an enlarged view of the region 1D marked by the dashed box in FIG. 1B.

FIG. 1E is a cross-sectional perspective view taken along line I-I in FIG. 1A.

FIG. 1F is an enlarged view of the region 1F marked by the dashed box in FIG. 1E.

FIG. 1G is a cross-sectional perspective view taken along line II-II in FIG. 1A.

FIG. 1H is an enlarged view of the region 1H marked by the dashed box in FIG. 1G.

FIG. 2A is a top, side perspective view of the electrical connector of FIG. 1A.

FIG. 2B is a bottom, side perspective view of the electrical connector of FIG. 2A.

FIG. 2C is an enlarged view of the region 2C marked by the dashed box in FIG. 2A.

FIG. 2D is an enlarged view of the region 2D marked by the dashed box in FIG. 2B, illustrating solder balls attached to tail ends of conductive elements of the electrical connector.

FIG. 2E is a partially exploded perspective view of the electrical connector of FIG. 2A.

FIG. 3A is a perspective view of an insulative housing of the electrical connector of FIG. 2A.

FIG. 3B is an enlarged view of the region 3B marked by the dashed box in FIG. 3A.

FIG. 3C is an enlarged view similar to FIG. 3B, showing the conductive elements of the electrical connector held by the insulative housing.

FIG. 3D is an enlarged view similar to FIG. 3B, showing the conductive elements and a first conductive member of the electrical connector held by the insulative housing.

FIG. 3E is an enlarged view similar to FIG. 3B, showing the conductive elements, the first conductive member, a second conductive member, and a third conductive member of the electrical connector held by the insulative housing.

FIG. 4A is a perspective view of the electrical connector of FIG. 2A, corresponding to a first slot, with the insulative housing hidden.

FIG. 4B is a bottom perspective view of the electrical connector of FIG. 4A.

FIG. 4C is an enlarged view of the region 4C marked by the dashed box in FIG. 4A.

FIG. 4D is an enlarged view of the region 4D marked by the dashed box in FIG. 4B.

FIG. 4E is a front view of the components shown in FIG. 4A.

FIG. 4F is a top view of the components shown in FIG. 4A.

FIG. 4G is a bottom view of the components shown in FIG. 4A.

FIG. 4H is a side view of the components shown in FIG. 4A.

FIG. 5A is a top, side perspective view of the first conductive member of FIG. 4A.

FIG. 5B is a bottom, side perspective view of the first conductive member of FIG. 5A.

FIG. 5C is an enlarged view of the region 5C marked by the dashed box in FIG. 5A.

FIG. 5D is an enlarged view of the region 5D marked by the dashed box in FIG. 5B.

FIG. 5E is a side view of the first conductive member of FIG. 5A.

FIG. 6A is a perspective view of the second conductive member of FIG. 4A.

FIG. 6B is another perspective view of the second conductive member of FIG. 6A.

FIG. 6C is an enlarged view of the region 6C marked by the dashed box in FIG. 6A.

FIG. 6D is an enlarged view of the region 6D marked by the dashed box in FIG. 6B.

FIG. 7A is a perspective view of four conductive elements marked by the dashed box 7A in FIG. 4F, showing an exemplary solder ball attached to a terminal tail end.

FIG. 7B is another perspective view of the four conductive elements of FIG. 7A.

FIG. 7C is a side view of the four conductive elements of FIG. 7A.

FIG. 8A is a perspective view of an electronic system including a circuit board and an electrical connector, according to some embodiments.

FIG. 8B is an exploded view of the electronic system of FIG. 8A.

FIG. 8C is an enlarged view of the region 8C marked by the dashed box in FIG. 8A.

FIG. 8D is an enlarged view of the region 8D marked by the dashed box in FIG. 8B.

FIG. 8E is a cross-sectional perspective view taken along line III-III in FIG. 8A.

FIG. 8F is a cross-sectional perspective view taken along line IV-IV in FIG. 8A.

FIG. 9 is a partially exploded view of the electrical connector of FIG. 8A.

### DETAILED DESCRIPTION

The inventors have recognized and appreciated connector design techniques for high density, high speed, and high performance electronic systems. Increasing transmission rate poses significant challenges for maintaining and/or improving the integrity of the signals passing through a connector. The inventors have recognized and appreciated designs that can improve both insertion loss (IL) and return loss (RL) and crosstalk of connectors. A connector satisfying the mechanical requirements of the DDR specification at the performance required for DDR5 and beyond is used as an example of a connector in which these techniques have been applied.

According to aspects of the present disclosure, an electrical connector may include a housing and a plurality of conductive elements held by the housing. The insulative housing may include a mating face, a mounting face, and a slot recessed into the insulative housing from the mating face in a mating direction. The slot may be elongated in a longitudinal direction perpendicular to the mating direction. Each conductive element may include a mating end comprising a mating contact portion curving into the slot, a tail end extending out of the mounting face of the housing, and an intermediate portion between the mating end and the tail end. The conductive elements may be arranged in a first row and a second row disposed on opposite sides of the slot. Each row may include terminals configured for signal transmission (which may be referred to as “signal terminals”) and terminals configured for reference (which may be referred to as “ground terminals”).

In some embodiments, the electrical connector may include a first conductive member. The first conductive member may be held by the insulative housing between the first row and the second row. The first conductive member may include a planar body having a broadside facing the mating face of the housing and substantially perpendicular to the mating direction. In some embodiments, the planar body of the first conductive member may be disposed on the mounting face of the housing.

The first conductive member may include a plurality of first beams extending from a first edge of the planar body and towards respective ground terminals in the first row of conductive elements to couple the ground terminals in the first row. Each first beam may include a first subportion extending from the first edge in the mating direction, and a second subportion extending from the first subportion and configured to contact the intermediate portion of a respective ground terminal in the first row.

The first conductive member may include a plurality of second beams extending from a second edge of the planar body and towards respective ground terminals in the second row of conductive elements to couple the ground terminals in the second row. Each first beam may include a first subportion extending from the second edge in the mating direction, and a second subportion extending from the first subportion and configured to contact the intermediate portion of a respective ground terminal in the second row. The plurality of first beams and the plurality of second beams may be offset from each other in the longitudinal direction.

The inventors have recognized and appreciated that such a first conductive member (e.g., configuration, orientation) can reduce insertion loss (IL) and return loss (RL) for the electrical connector, improving signal integrity. In addition, the first conductive member can provide a conductive path for the ground terminals in both the first row and the second row and therefore reduce potential differences among the ground terminals, reducing crosstalks and improving signal integrity.

The inventors have recognized and appreciated that coupling the first conductive member with the ground terminals at the intermediate portions can avoid changing the footprint of the connector at the mounting interface, and thus therefore avoid changing to the layout of conductive pads on the circuit board for establishing connections with the electrical connector. Such a configuration may enable the connector to provide improved signal transmission performance while being compatible with existing standards, for example, DDR standards such as DDR4 or DDR5. Such a configuration may also enable the electrical connector to meet the performance requirements specified by higher DDR standards.

In some embodiments, the electrical connector may also include a second conductive member. The second conductive member may be disposed in the housing at a side of the first row and separate from the slot by the first row. The second conductive member may be configured for electrically coupling the ground terminals in the first row at the intermediate portions.

The second conductive member may include a planar body orthogonal to the planar body of the first conductive member, and a plurality of beams extending from the planar body towards the ground terminals in the first row. The inventors have recognized and appreciated that such a second conductive member (e.g., configuration, orientation) can provide a conductive path between the ground terminals in the first row and reduce potential differences among these ground terminals, reducing crosstalks and improving signal integrity.

The inventors have recognized and appreciated that coupling the second conductive member with the ground terminals at the intermediate portions can avoid changing the footprint of the tail ends at the mounting interface, and thus therefore avoid changing to the layout of the conductive pads on the circuit board for establishing connections with the electrical connector. Such a configuration may enable the connector to provide improved signal transmission performance while being compatible with existing standards, for example, DDR standards such as DDR4 or DDR5. Such a configuration may also enable the electrical connector to meet the performance requirements specified by higher DDR standards.

In some embodiments, the tail ends of the conductive elements may be configured to be attached with solder balls. In some embodiments, the tail ends of the conductive elements may also be configured with Surface Mounting Technology (SMT) techniques such as wave soldering, ultrasonic soldering, laser welding, or other Through-Hole Technology (THT) techniques.

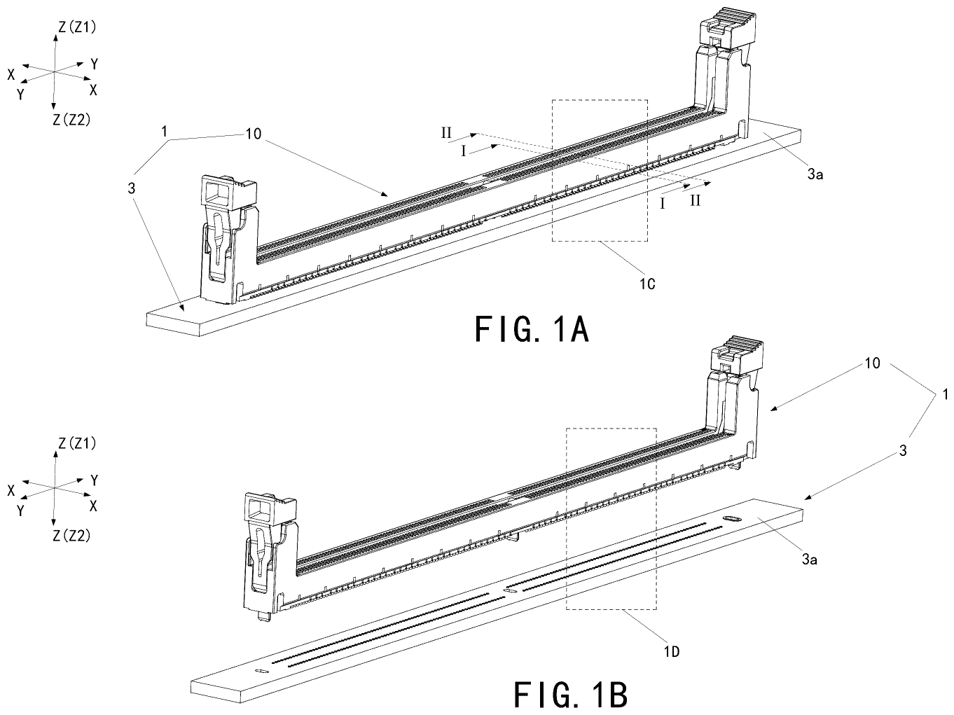

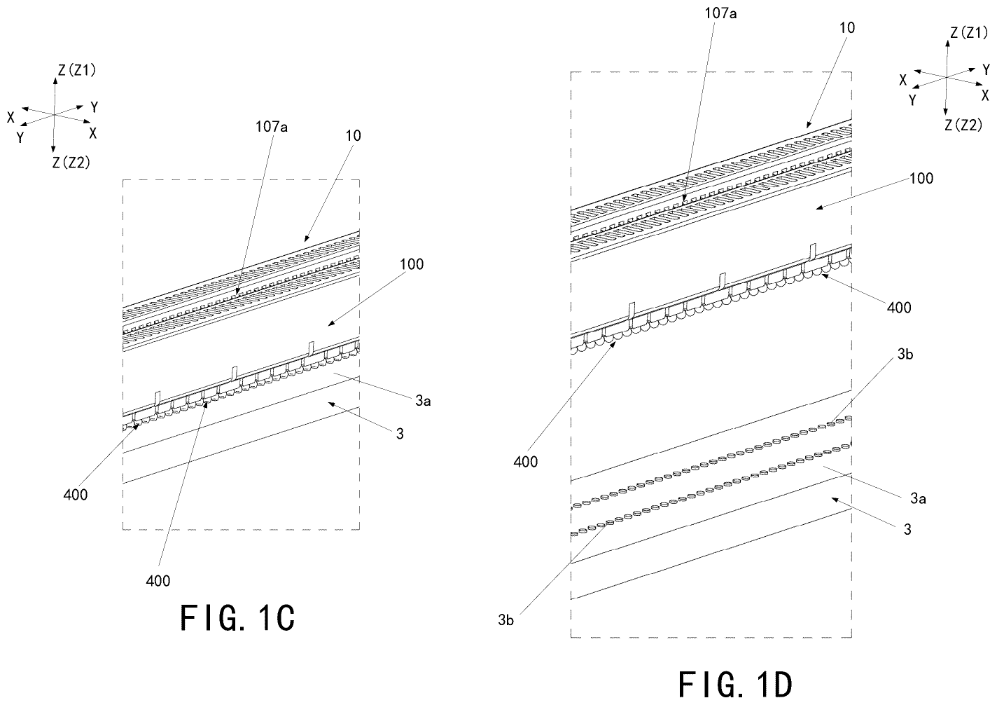

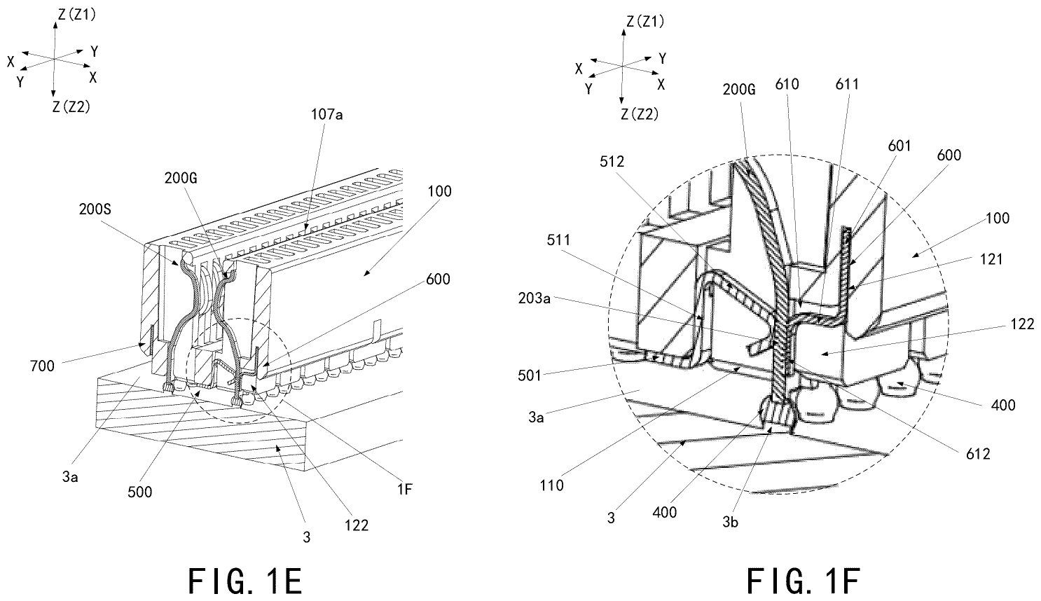

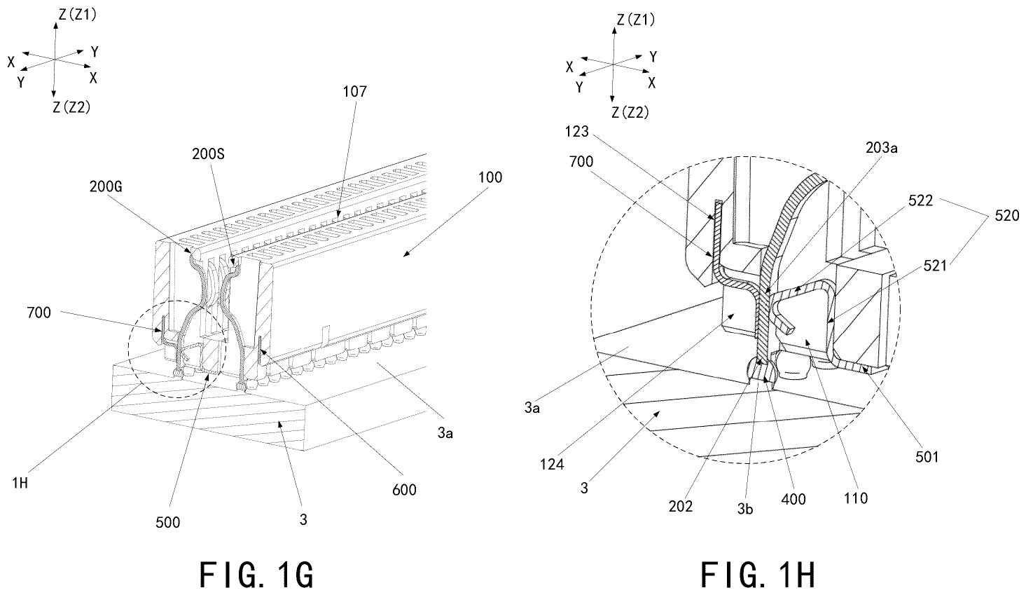

According to aspects of the present disclosure, FIGS. 1A to 7C illustrate an electrical connector 10. For the sake of clarity and conciseness of the description, a lateral direction X-X, a longitudinal direction Y-Y and a vertical direction Z-Z may be shown in FIGS. 1A to 7C. The lateral direction X-X, the longitudinal direction Y-Y and the vertical direction Z-Z are perpendicular to each other. The lateral direction X-X may refer to a width direction of the electrical connector 10. The longitudinal direction Y-Y may refer to a length direction of the electrical connector 10. The vertical direction Z-Z may refer to a height direction of the electrical connector 10. The vertical direction Z-Z includes a first vertical direction Z1 oriented in the vertical direction Z-Z, and a second vertical direction Z2 oriented in the vertical direction Z-Z and opposite to the first vertical direction Z1. For example, the first vertical direction Z1 and the second vertical direction Z2 are parallel to the vertical direction Z-Z and are opposite to each other. The first vertical direction Z1 may also be referred to as “a vertical upward direction”, and the second vertical direction Z2 may also be referred to as “a vertical downward direction”.

FIGS. 1A to 1H illustrate an electronic system 1 including at least an electrical connector 10 and a circuit board 3, according to the first embodiment of the present application. The electrical connector 10 is configured for establishing an electrical connection between the circuit board 3 and another electrical component (not shown). As shown in FIGS. 1A, 1C, and 1E to 1H, the electrical connector 10 is mounted to the circuit board 3 and is ready to establish a separable connection with another electrical component, thereby mechanically and electrically connecting the electrical component to the circuit board 3. The electrical component may be, for example, another circuit board or another electrical connector.

As exemplarily illustrated in FIGS. 1A and 1B, the electrical connector 10 may be configured as a memory card connector to be used in a computer device. In this case, the circuit board 3 may be a motherboard of the computer device, and the electrical component may be a memory card. The electrical connector 10 may provide an interface that meets DDR specifications of DDR4, DDR5, and higher performance requirements. The electrical connector 10 may also be referred to as “a card edge connector”. The electrical connector design techniques according to the present application will be described below by taking such an electrical connector as an example, but it should be appreciated that the present application is not limited thereto.

As shown in FIG. 1D, the circuit board 3 includes a surface 3a and a plurality of conductive pads 3b disposed on the surface 3a. The plurality of conductive pads 3b may be arranged on the surface 3a in two pad rows each extending in the longitudinal direction Y-Y and spaced apart from each other. The plurality of conductive pads 3b may be suitable to be attached with solder balls when the electrical connector 10 is mounted to the circuit board 3 by using Ball Grid Array (BGA) packaging technology, thereby establishing electrical connections with conductive elements of the electrical connector 10, as will be described in detail below. Each conductive pad 3b may have a circular shape. However, it should be appreciated that the shapes of the conductive pads 3b are not limited thereto, and that the conductive pads 3b may have any other shape, such as square or ovoid. It should also be appreciated that only a part of the circuit board 3 is schematically shown in the accompanying drawings, rather than the entire circuit board 3, and that the specific type of the circuit board 3 is not limited thereto.

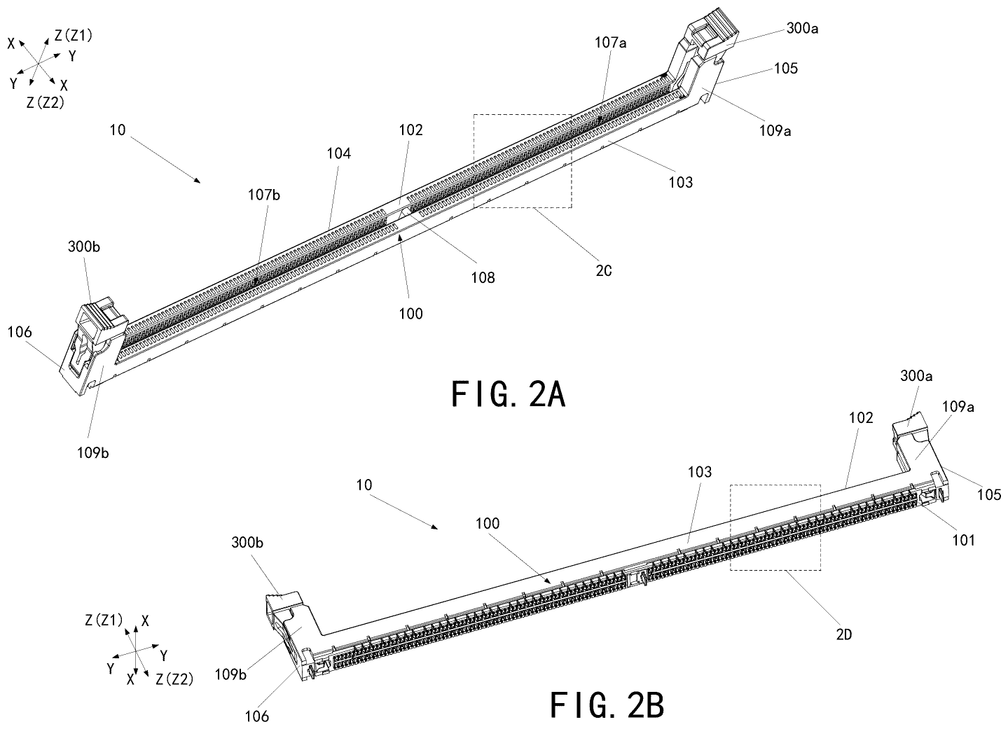

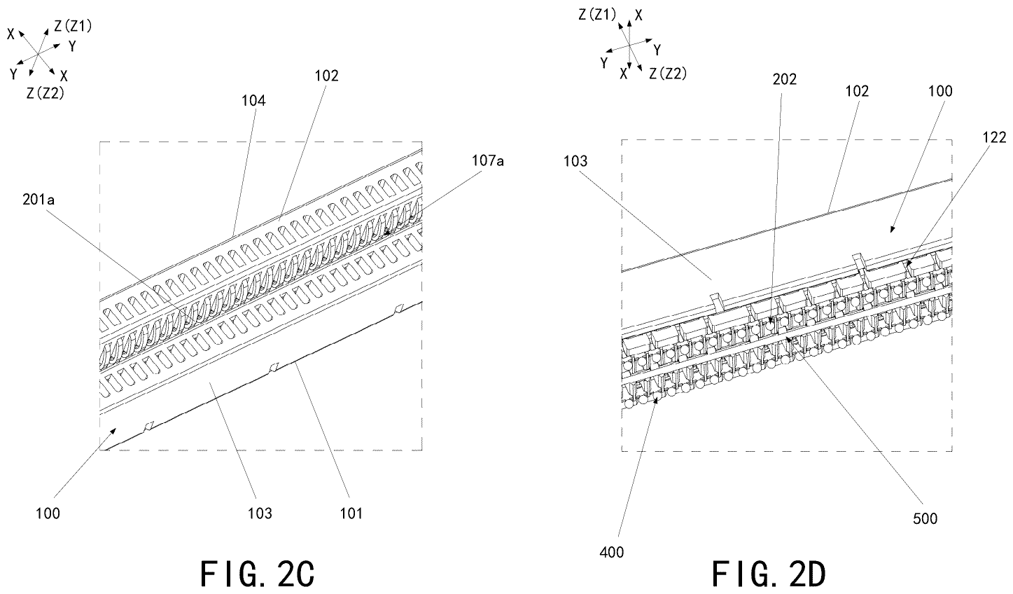

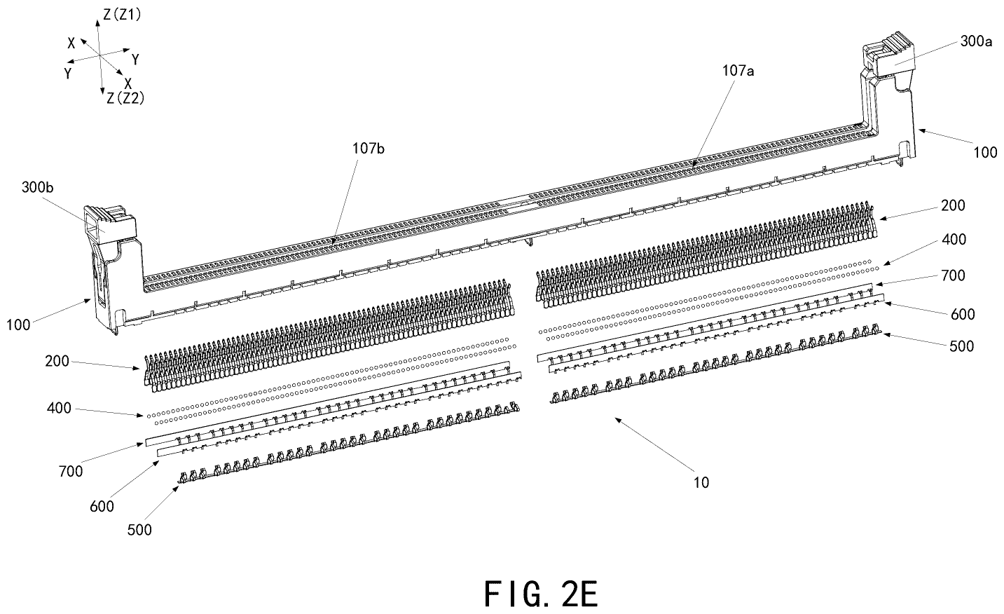

FIGS. 2A to 7C illustrate the electrical connector 10 in detail. As shown in FIGS. 2A to 2E, the electrical connector 10 includes an insulative housing 100 and a plurality of conductive elements (which may also be referred to as “conductive elements,” “electrical conductors,” or “terminals”) 200 disposed in the insulative housing 100. The insulative housing 100 may be formed from an insulative material. Examples of insulative materials that are suitable for forming the insulative housing 100 include, but are not limited to, plastic, nylon, liquid crystal polymer (LCP), polyphenylene sulfide (PPS), high temperature nylon or polyphenylene oxide (PPO) or polypropylene (PP). Each of the plurality of conductive elements 200 may be formed from a conductive material. The conductive material suitable for forming the conductive elements may be a metallic material, such as copper or copper alloy.

The insulative housing 100 may include a first face 101 and a second face 102 opposite to each other in the vertical direction Z-Z, a third face 103 and a fourth face 104 opposite to each other in the lateral direction X-X, a fifth face 105 and a sixth face 106 opposite to each other in the longitudinal direction Y-Y, and a first slot 107a and a second slot 107b recessed into the insulative housing 100 from the second face 102 in the vertical direction Z-Z (here, the second vertical direction Z2), respectively. The first slot 107a and the second slot 107b are each elongated in the longitudinal direction Y-Y. The first slot 107a and the second slot 107b may be separated from each other in the longitudinal direction Y-Y by a separator 108 of the insulative housing 100. The separator 108 may be an integral portion of the insulative housing 100. The first slot 107a may be configured for receiving a first insert portion (not shown) of an electrical component, such as a memory card, and the second slot 107b may be configured for receiving a second insert portion (not shown) of the electrical component. The separator 108 may guide an insertion of the first insert portion and the second insert portion of the electrical component into the first slot 107a and the second slot 107b. The first face 101 faces towards the second vertical direction Z2, and the second face 102 faces towards the first vertical direction Z1. As will be described in detail below, the plurality of conductive elements 200 may extend out of the first face 101 of the insulative housing 100 in the vertical direction Z-Z (here, the second vertical direction Z2). The first face 101 may be referred to as “a mounting face”, and the second face 102 may be referred to as “a mating face”. The mounting face and the mating face may be parallel to each other. The direction in which the slot is recessed into the insulative housing 100 or the direction towards which the mating face faces (herein, the vertical direction Z-Z) may be referred to as “a mating direction”. The direction towards which the mounting face faces may be referred to as “a mounting direction”. The mating direction and the mounting direction are parallel to each other. Thus, the electrical connector 10 is a vertical card edge connector. However, it should be appreciated that the present application is not limited thereto. In some embodiments, the mounting face and the mating face may be perpendicular to each other, and the mating direction and the mounting direction may be perpendicular to each other. In this case, the electrical connector is a right-angle card edge connector. In addition, although the insulative housing 100 is shown as including two slots, in some embodiments, the insulative housing 100 may have a single slot or more than two slots.

The insulative housing 100 may also include a first tower portion 109a and a second tower portion 109b extending from the second face 102 in the first vertical direction Z1. The first tower portion 109a and the second tower portion 109b may be, respectively, adjacent to the fifth face 105 and the sixth face 106, e.g., adjacent to opposite ends of the insulative housing 100 in the longitudinal direction Y-Y. The first tower portion 109a and the second tower portion 109b may define a receiving space therebetween. The electrical connector 10 may also include a first latch 300a and a second latch 300b mounted on the first tower portion 109a and the second tower portion 109b, respectively. When the electrical component, such as a memory card, is inserted into the electrical connector 10, the electrical component may be received in the receiving space between the first tower portion 109a and the second tower portion 109b, the first insert portion and the second insert portion of the electrical component are inserted into the first slot 107a and the second slot 107b, respectively, and the first latch 300a and the second latch 300b engage with corresponding structures (not shown) of the electrical component to reliably lock the electrical component into position relative to the electrical connector 10. It should be appreciated that the configurations of the electrical connector 10 are not limited thereto. In some embodiments, the electrical connector 10 may not have the first tower portion 109a, the second tower portion 109b, the first latch 300a, and the second latch 300b, or the electrical connector 10 may have any other type of locking mechanisms.

As shown in FIGS. 1E to 1H and 2C to 2E, the plurality of conductive elements 200 are disposed in the insulative housing 100. The plurality of conductive elements 200 include a first portion disposed in the first slot 107a and a second portion disposed in the second slot 107b. The specific configuration of the electrical connector 10 will be described below in connection with the conductive elements 200 disposed in the first slot 107a and the components associated therewith.

FIG. 2E illustrates the configurations of the electrical connector 10 at the first slot 107a and the second slot 107b in detail. As shown in FIG. 2E, the electrical connector 10 includes a plurality of conductive elements 200 disposed in the first slot 107a of the insulative housing 100 and a plurality of solder balls 400, a first conductive member 500, a second conductive member 600, and a third conductive member 700 associated with the conductive elements 200. Also, as shown in FIG. 2E, the configurations of the electrical connector 10 at the second slot 107b may be the same as or similar to the configuration thereof at the first slot 107a. Thus, the identical or similar components of the electrical connector 10 are labeled in FIG. 2E with the same reference signs and, for the sake of brevity, details of these identical or similar components may not be repeated.

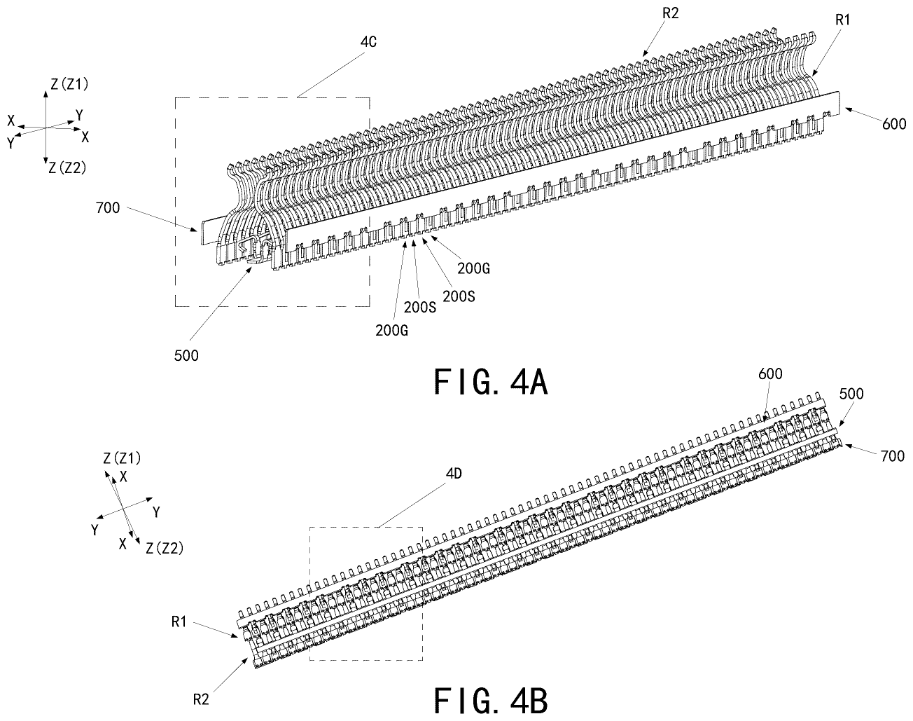

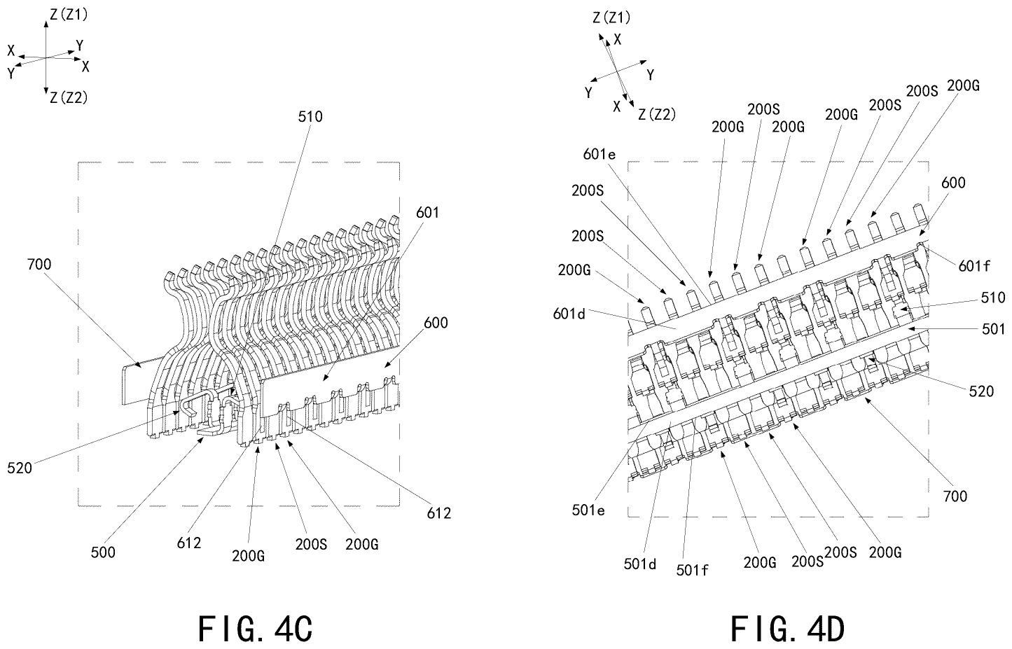

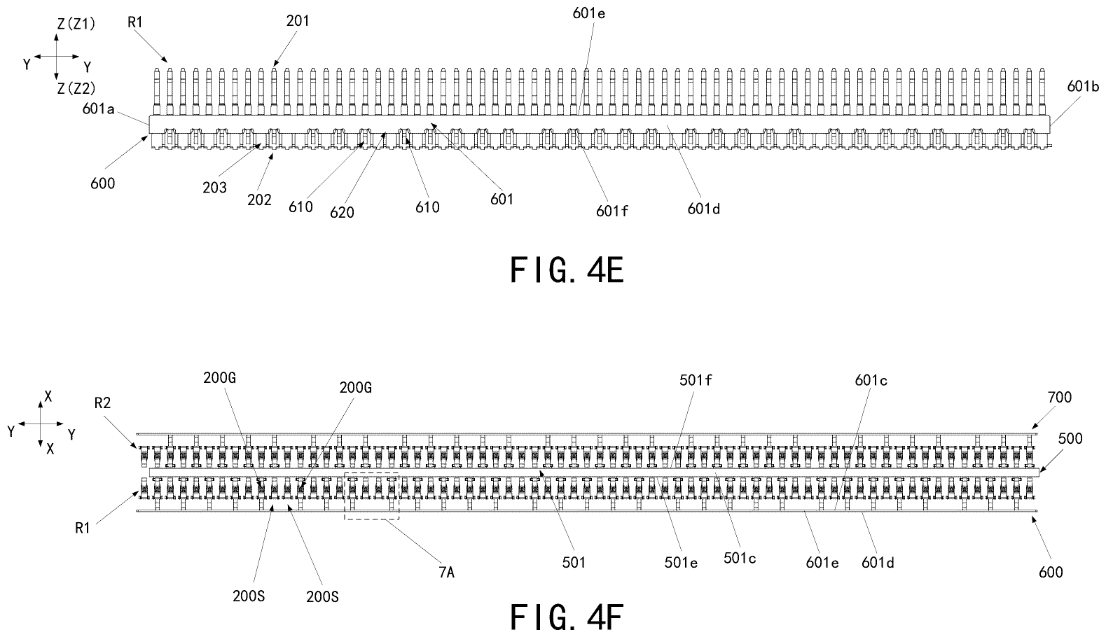

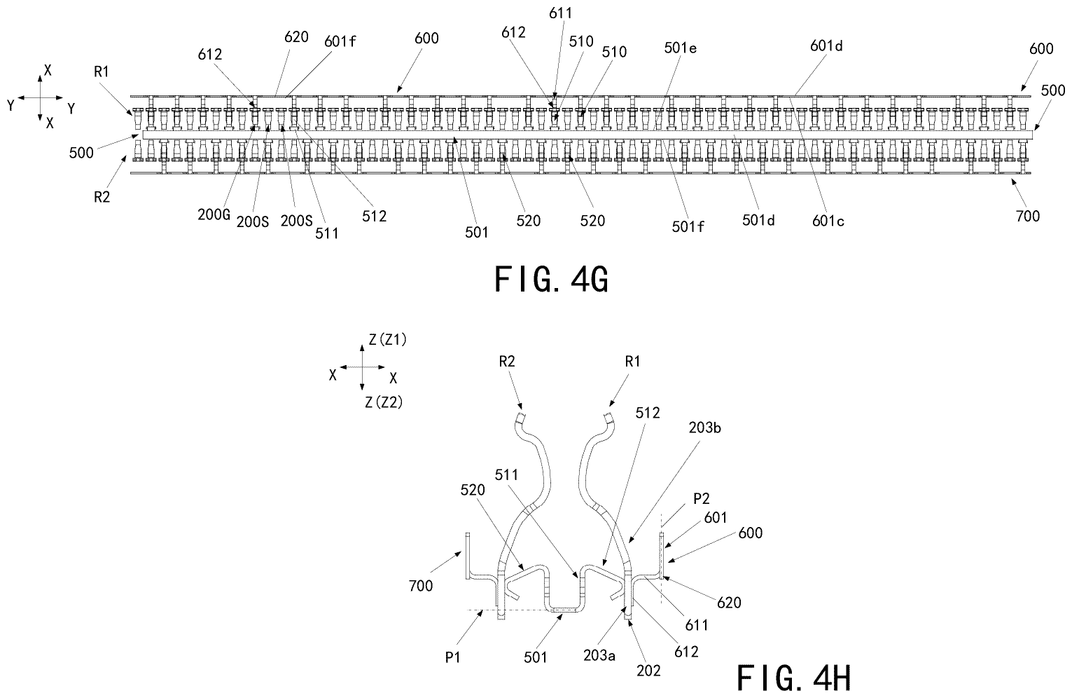

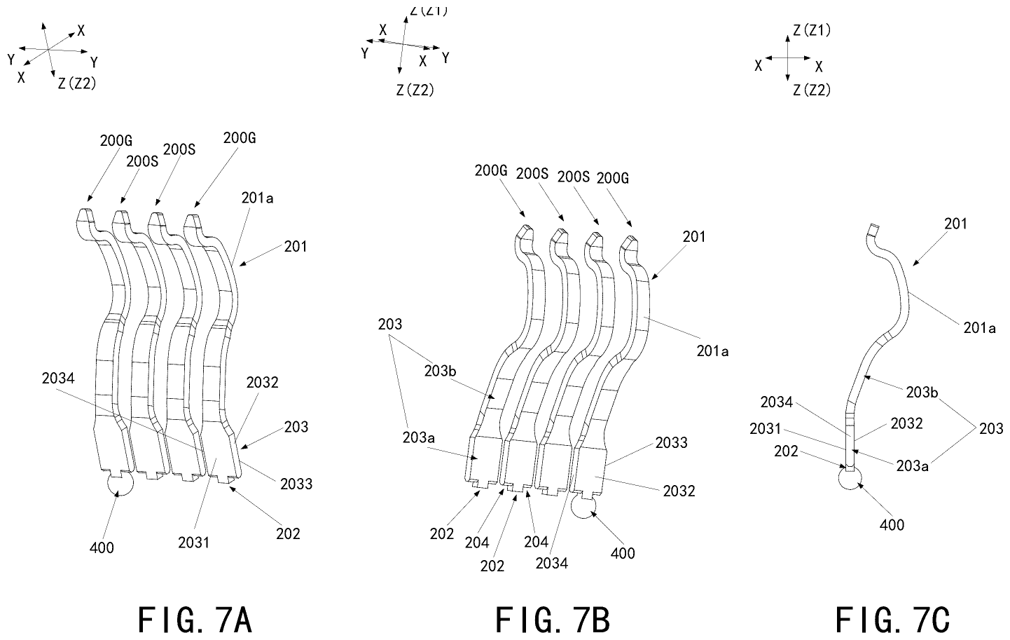

FIGS. 4A to 4H illustrate in detail the conductive elements 200 corresponding to the first slot 107a and the first conductive member 500, the second conductive member 600, and the third conductive member 700 associated with these conductive elements 200 of the electrical connector 10 in an assembled state in the electrical connector 10. FIGS. 7A to 7C illustrate in detail the configuration of four conductive elements 200 marked by the dashed box 7A in FIG. 4F. These conductive elements 200 include two ground terminals 200G and two signal terminals 200S disposed between the ground terminals 200G. The plurality of conductive elements 200 of the electrical connector 10 may have the same configurations.

As shown in FIGS. 7A to 7C, the four conductive elements 200 may have the same configurations. These conductive elements 200 include two signal terminals 200S and two ground terminals 200G. Each conductive element 200 includes a mating end 201, a tail end 202 opposite to the mating end 201, and an intermediate portion 203 extending between the mating end 201 and the tail end 202. The mating end 201 of the conductive element 200 has a mating contact portion 201a. The plurality of conductive elements 200 are disposed in the insulative housing 100 with the mating contact portions 201a of the mating ends 201 extending into the first slot 107a (FIG. 2C) (for example, the mating ends 201 are exposed in the first slot 107a) for contacting with a corresponding conductive portion on the first insert portion of the electrical component, such as a memory card, and with the tail ends 202 at least partially located outside of the insulative housing 100 (FIG. 2D) for establishing electrical connections with corresponding conductive pads 3b on the surface 3a of the circuit board 3. In some embodiments, as shown in FIG. 2D, the intermediate portion 203 of each of the plurality of conductive elements 200 may extend out of the insulative housing 100 from the first face 101 such that the tail end 202 is located entirely outside of the insulative housing 100. In some embodiments, a portion of the tail end 202 may be disposed in the insulative housing 100 while the remainder is disposed outside of the insulative housing 100. In this case, the tail end 202 of each of the plurality of conductive elements 200 extends out of the insulative housing 100 from the first face 101.

With reference to FIGS. 7A to 7C, the tail end 202 of the conductive element 200 may be configured to be attached with a solder ball 400 and to be connected to a corresponding conductive pad 3b on the circuit board 3 by using the solder ball 400 when the electrical connector 10 is mounted to the circuit board 3. For example, the tail end 202 of the conductive element 200 of the electrical connector 10 is configured to be connected to a corresponding conductive pad 3b on the circuit board 3 via BGA attachment. BGA attachment is a surface mount technology (SMT). The solder ball 400 may be, for example, a tin ball. The solder ball 400 may be fused to the tail end 202 of the conductive element 200. This may be accomplished by heating the solder to be fully liquefied and adhere to the tail end 202. When the electrical connector 10 is mounted to the circuit board 3, the electrical connector 10 may be placed on the surface 3a of the circuit board 3 such that the tail end 202 and the solder ball 400 attached thereto are aligned with a corresponding conductive pad 3b on the surface 3a of the circuit board 3. Then, the solder ball 400 may be heated (e.g., by placing the electrical connector 10 and the circuit board 3 in a reflow oven) and melted to adhere to the conductive pad 3b while the solder ball 400 remains adhered to the tail end 202. After the solder ball 400 has cooled, the tail end 202 is attached and secured to the conductive pad 3b by the solder ball 400. In this way, the tail ends 202 are mechanically and electrically connected to the conductive pads 3b by the solder balls 400, thereby establishing reliable electrical connections between the electrical connector 10 and the circuit board 3. FIGS. 7A to 7C illustrate that one of the ground terminals 200G is attached with a solder ball 400 on the tail end 202 thereof.

In some embodiments, the solder ball 400 may be provided by a manufacturer of the electrical connector 10 and may be attached to the tail end 202 of the conductive element 200 during the manufacture of the electrical connector 10. In some embodiments, the solder ball 400 may be provided by other manufacturers, such as a manufacturer that processes the electrical connector 10 or a manufacturer of the electronic system 1, and may be attached to the tail end 202 of the conductive element 200 before the electrical connector 10 is mounted to the circuit board 3.

At least a portion of the intermediate portion 203 of the conductive element 200 may extend in the vertical direction Z-Z. With reference to FIGS. 7A to 7C, the intermediate portion 203 of the conductive element 200 may include a vertical subportion 203 an extending in the vertical direction Z-Z. The vertical subportion 203a includes two broadsides 2031 and 2032 opposite to each other in the lateral direction X-X, and two narrow sides 2033 and 2034 opposite to each other in the longitudinal direction Y-Y. The broadsides of the vertical subportion may be referred to as “surfaces”, and the narrow side thereof may be referred to as “side edges”.

In some embodiments, as shown in FIGS. 7B and 7C, the tail end 202 of the conductive element 200 may extend from the vertical subportion 203a of the intermediate portion 203. A width of the vertical subportion 203a in the longitudinal direction Y-Y (e.g., between the two narrow sides 2033 and 2034) may be greater than a width of the tail end 202 in the longitudinal direction Y-Y. For example, the tail end 202 is narrower than the vertical subportion 203a of the intermediate portion 203 in the longitudinal direction Y-Y. The tail end 202 is indented relative to the two narrow sides 2033 and 2034 of the vertical subportion 203a in the longitudinal direction Y-Y to define a pair of indentations (which may be referred to as “indented spaces”) 204 (FIG. 7B). Such a tail end 202 allows a solder ball 400 with a diameter greater than the width of the tail end 202 in the longitudinal direction Y-Y to be attached to the tail end 202. For example, the indentations 204 may be filled with solder when the electrical connector 10 is mounted to the circuit board 3. The integrity of the signal passing through the electrical connector 10 can be improved by the configuration of the narrower tail ends 202 having the indentations 204, the attachment of the larger solder balls 400 to the narrower tail ends 202 of the conductive elements 200, and/or the combination thereof.

In some embodiments, the intermediate portion 203 may include another subportion between the tail end 202 and the vertical subportion 203a of the intermediate portion 203. In this case, the tail end 202 may be narrower than the subportion in the longitudinal direction Y-Y to provide the aforementioned configurations and benefits.

As shown in FIGS. 7B and 7C, the tail end 202 may be a straight subportion extending from the vertical subportion 203a of the intermediate portion 203 in the second vertical direction Z2. It should be appreciated that the present application is not limited thereto. In some embodiments, the shape of the tail end 202 may be designed in various ways to be suitable for solder ball attachment. For example, the tail end 202 may be curved to have a portion extending in the lateral direction X-X, the portion is capable of providing a surface for attachment with the solder ball 400.

In some embodiments, as shown in FIGS. 7B and 7C, the intermediate portion 203 of each conductive element 200 may include a subportion 203b connecting the vertical subportion 203a and the mating end 201. For example, the subportion 203b extends between the vertical subportion 203a and the mating end 201. The subportion 203b extends oppositely to the tail end 202 from the vertical subportion 203a. The subportion 203b may be inclined relative to the vertical direction Z-Z towards the first slot 107a such that the mating contact portion 201a of the mating end 201 extends into the first slot 107a. A width of the vertical subportion 203a in the longitudinal direction Y-Y may be greater than a width of the subportion 203b in the longitudinal direction Y-Y. In some embodiments, the intermediate portion 203 may be devoid of the subportion 203b, and the mating end 201 may extend directly from the vertical subportion 203a.

In some embodiments, the mating end 201, the tail end 202, and the intermediate portion 203 of each conductive element 200 may have consistent thicknesses along an extending direction of the conductive element 200.

Turning back to FIGS. 4A to 4H, for the plurality of conductive elements 200 of the electrical connector 10 corresponding to the first slot 107a, the conductive elements 200 are arranged in a first row R1 and a second row R2 each extending in the longitudinal direction Y-Y, mutually opposed and spaced apart from each other across the first slot 107a. The first row R1 may include a first side facing towards the second row R2 and a second side facing away from the second row R2. The first side and the second side may be two sides of the first row R1 opposite to each other in the lateral direction X-X. Similarly, the second row R2 may include a third side facing towards the first row R1 and a fourth side facing away from the first row R1. The third side and the fourth side may be two sides of the second row R2 opposite to each other in the lateral direction X-X. The first row R1 and the second row R2 are disposed at both sides of the first slot 107a in the lateral direction X-X, respectively. The mating ends 201 of the conductive elements 200 of the first row R1 and the mating ends 201 of the conductive elements 200 of the second row R2 are exposed in the first slot 107a. For example, the mating ends 201 may be curved into the first slot 107a. The subportions 203b of the intermediate portions 203 of the conductive elements 200 of the first row R1 may be inclined towards the second row R2 relative to the vertical direction Z-Z, and the subportions 203b of the intermediate portions 203 of the conductive elements 200 of the second row R2 may be inclined towards the first row R1 relative to the vertical direction Z-Z. The mating contact portions 201a of the mating ends 201 of the conductive elements 200 of the first row R1 and the second row R2 may extend into the first slot 107a.

Each of the first row R1 and the second row R2 may include signal terminals 200S and ground terminals 200G. For each of the first row R1 and the second row R2, the signal terminals 200S are grouped into a plurality of groups, with a single signal terminal 200S as a group and/or with a pair of signal terminals 200S as a group, and the ground terminals 200G are arranged between adjacent ones of the plurality of groups to separate the plurality of groups from each other. For example, each pair of signal terminals 200S may be configured to transmit differential signals. In this case, one of the pair of signal terminals 200S may be energized by a first voltage, and the other signal terminal may be energized by a second voltage. The voltage difference between the pair of signal terminals 200S represents a signal. Separating the plurality of groups from each other with the ground terminals 200G can reduce crosstalk and thus improve signal integrity (SI). In some embodiments, more than two signal terminals 200S may be disposed between two adjacent ground terminals 200G.

As described above, the tail ends 202 of the conductive elements 200 of the first row R1 and the second row R2 are configured to be connected to the corresponding conductive pads 3b on the circuit board 3 via the BGA attachment by using the solder balls 400. Such a configuration can improve the integrity of the signal passing through the electrical connector 10, thereby improving the signal transmission performance of the electrical connector 10.

As shown in FIGS. 1E to 1H, 2E, and 4A to 4H, the first conductive member 500 may be held by the insulative housing 100 and configured for electrically coupling the plurality of ground terminals 200G together by electrically coupling with the intermediate portions 203 of the plurality of ground terminals 200G. In particular, the first conductive member 500 is disposed between the first row R1 and the second row R2 (e.g., positioned at the first side of the first row R1 and at the third side of the second row R2) and is configured for electrically coupling the ground terminals 200G of the first row R1 and the ground terminals 200G of the second row R2 together. It should be appreciated that the plurality of ground terminals 200G may be all or selected ones of the ground terminals 200G of the first row R1 and all or selected ones of the ground terminals 200G of the second row R2.

With such a configuration, the insertion loss (IL) and the return loss (RL) of the signals passing through the electrical connector 10 can be reduced, thereby improving the integrity of the signal passing through the electrical connector 10. Furthermore, with such a configuration, it is possible to provide a conductive pathway between the ground terminals 200G of the first row R1 and the ground terminals 200G of the second row R2 to eliminate as much as possible the potential differences among the ground terminals 200G, and to reduce the effect of the crosstalk, thereby improving the integrity of the signal passing through the electrical connector 10. In the case where such a configuration is incorporated in the electrical connector 10 in conjunction with the BGA attachment, the integrity of the signal passing through the electrical connector 10 can be significantly improved, thereby improving the signal transmission performance of the electrical connector 10. In addition, since the first conductive member 500 is configured to be electrically coupled to the ground terminals 200G at the intermediate portions 203, there is no change to the layout of the tail ends 202 at the mounting interface of the electrical connector 10, and thus there is no change to the layout of the conductive pads on the circuit board 3 for establishing connections with the electrical connector 10, and there is no significant increase or even no increase in the footprint of the electrical connector 10 on the circuit board 3. This enables the electrical connector 10 to provide improved signal transmission performance while still being compatible with existing standards, for example, DDR standards such as DDR4 or DDR5. In addition, this allows the electrical connector 10 to meet the performance requirements specified by higher DDR standards.

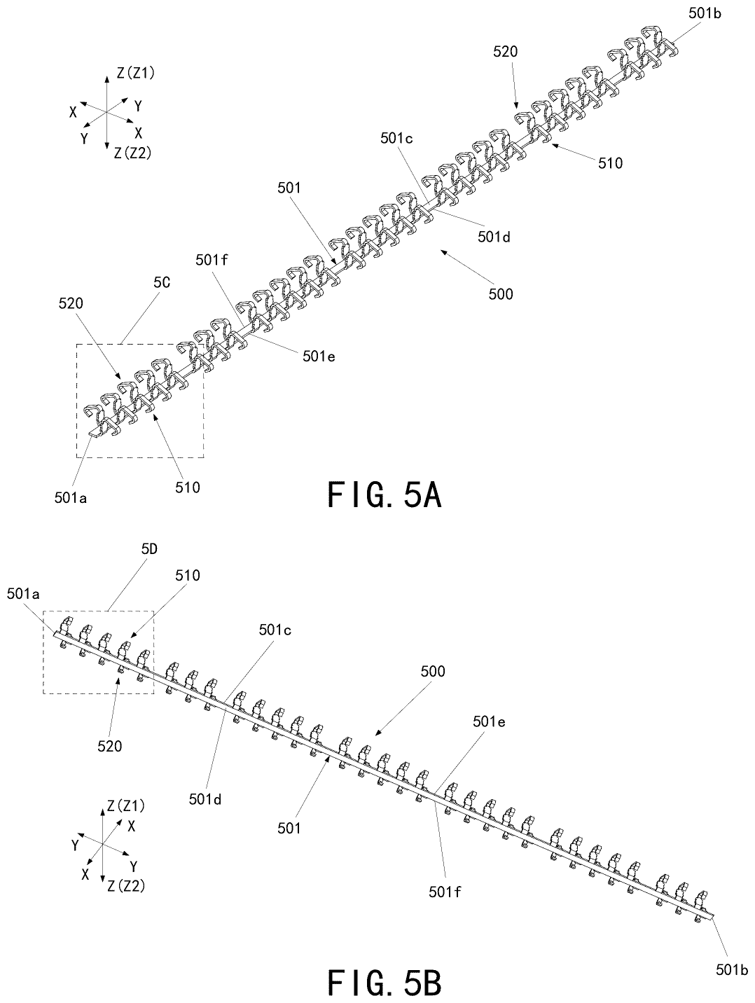

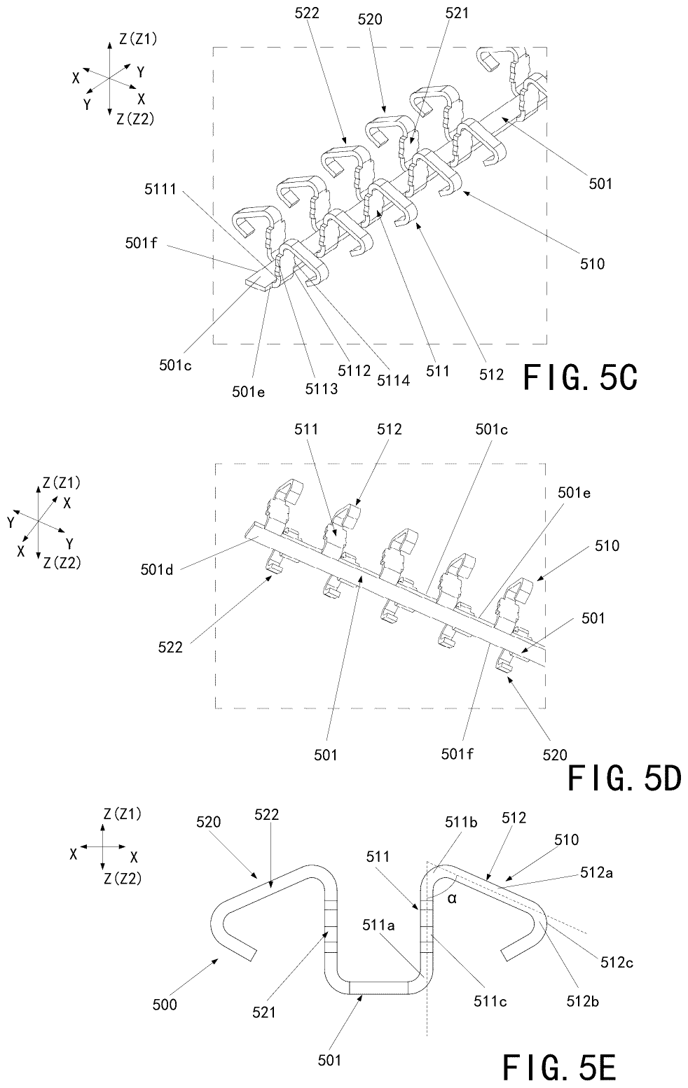

FIGS. 5A to 5E illustrate in detail an exemplary type of the first conductive member 500. As shown in FIGS. 5A to 5E, the first conductive member 500 may include a first body 501 and a plurality of first extensions. The first body 501 may be elongated in the longitudinal direction Y-Y. Each of the plurality of first extensions may extend from the first body 501 towards a corresponding ground terminal 200G of the first row R1 and the second row R2 to electrically couple with the intermediate portion 203 of the corresponding ground terminal 200G. The electrical coupling may be direct contact or capacitive coupling. With such a configuration, the first conductive member 500 may be electrically coupled to the corresponding ground terminals 200G of the first row R1 and the second row R2 by the plurality of first extensions and electrically couple the ground terminals 200G of the first row R1 and the ground terminals 200G of the second row R2 together by the first body 501.

In some embodiments, the first conductive member 500 may be formed from a metallic material, such as copper or copper alloy. In this case, each first extension of the first conductive member 500 may be in direct contact with the intermediate portion 203 of the corresponding ground terminal 200G. In some embodiments, the first conductive member 500 may be formed from a lossy material. In this case, each first extension of the first conductive member 500 may be in direct contact with or capacitively coupled to the intermediate portion 203 of the corresponding ground terminal 200G.

As shown in FIGS. 4H and 5A to FIG. 5E, the first body 501 may be in a shape of a flat strip and may extend in a first main plane P1 perpendicular to the vertical direction Z-Z. The first body 501 may include a first end 501a and a second end 501b opposite to each other in the longitudinal direction Y-Y, a first broadside 501c and a second broadside 501d opposite to each other in the vertical direction Z-Z, and a first narrow side 501e and a second narrow side 501f opposite to each other in the lateral direction X-X. The first body 501 may be continuously flat in the longitudinal direction Y-Y and the lateral direction X-X. The broadsides of the first body 501 may also be referred to as “surfaces” of the first body 501, and the narrow sides of the first body 501 may also be referred to as “side edges” of the first body 501. As shown in FIG. 4H, the first main plane P1 may be centered between the first broadside 501c and the second broadside 501d and parallel to the first broadside 501c and the second broadside 501d. The first main plane P1 may be defined by a major extension direction of the first body 501. The first main plane P1 may also be referred to as “a center plane” or “an extension plane” of the first body 501. As shown in FIGS. 4F to 4H, when the first conductive member 500 is held by the insulative housing 100, the first narrow side 501e of the first body 501 faces towards the first row R1 and the second narrow side 501f faces towards the second row R2, and the first broadside 501c of the first body 501 faces towards the first vertical direction Z1 and the second broadside 501d faces towards the second vertical direction Z2. Furthermore, the first main plane P1 is perpendicular to the vertical direction Z-Z. For example, the first conductive member 500 is oriented in such a manner that the first main plane P1 of the first body 501 is perpendicular to the vertical direction Z-Z. With such configuration and orientation of the first conductive member 500, the insertion loss (IL) and the return loss (RL) of the signal passing through the electrical connector 10 can be significantly reduced, thereby improving the integrity of the signal passing through the electrical connector 10.

With reference to FIGS. 5A to 5E, the plurality of first extensions of the first conductive member 500 may be in the form of resilient beams (or resilient arms). The plurality of first extensions may include a first beam (or arm) 510 and a second beam (or arm) 520. As shown in FIGS. 4C and 4H, each first beam 510 extends from the first narrow side 501e of the first body 501 towards a corresponding ground terminal 200G of the first row R1 and is resiliently pressed against the vertical subportion 203a of the intermediate portion 203 of the corresponding ground terminal 200G of the first row R1, and each second beam 520 extends from the second narrow side 501f of the first body 501 towards a corresponding ground terminal 200G of the second row R2 and is resiliently pressed against the vertical subportion 203a of the intermediate portion 203 of the corresponding ground terminal 200G of the second row R2. With such a configuration, the first conductive member 500 may be in direct contact with the corresponding ground terminals 200G of the first row R1 and the second row R2 through the first beam 510 and the second beam 520, and electrically connect the ground terminals 200G of the first row R1 and the ground terminals 200G of the second row R2 together through the first body 501. Since the beams are resiliently pressed against the corresponding ground terminals, reliable electrical connections can be established between the first conductive member 500 and the ground terminals. The first conductive member 500 may also be referred to as “a GND bar”.

As shown in FIGS. 5C to 5E, each first beam 510 may include a first subportion 511 and a second subportion 512, and each second beam 520 may include a first subportion 521 and a second subportion 522. As shown in FIG. 5E, the first beam 510 and the second beam 520 may have configurations symmetrical to each other. Thus, the configuration of the first beam 510 and the second beam 520 will be described below by taking the configuration of the first beam 510 as an example, and the configuration of the second beam 520 may not be repeated.

Each of the first beam 510 and the second beam 520 includes a first subportion (e.g., 511 and 521) and a second subportion (e.g., 512 and 522), the first subportion extends from a corresponding narrow side of the first body 501 in the first vertical direction Z1 and beyond the first broadside 501c, the second subportion extends from the first subportion away from the corresponding narrow side towards a corresponding ground terminal 200G of a corresponding row and is resiliently pressed against the vertical subportion 203a of the intermediate portion 203 of the corresponding ground terminal 200G. It should be appreciated that in some embodiments, the second subportion may also be resiliently pressed against another subportion (e.g., the subportion 203b) of the intermediate portion 203 of the corresponding ground terminal 200G.

Taking the first beam 510 as an example, as shown in FIGS. 5C to 5E, the first subportion 511 of the first beam 510 extends from the first narrow side 501e of the first body 501 in the first vertical direction Z1 and beyond the first broadside 501c. As shown in FIGS. 4H and 5E, the second subportion 512 extends from the first subportion 511 away from the first narrow side 501e towards the corresponding ground terminal 200G of the first row R1 and is resiliently pressed against the vertical subportion 203a of the intermediate portion 203 of the corresponding ground terminal 200G.

The first subportion 511 of the first beam 510 and the first subportion 521 of the second beam 520 may each extend perpendicularly to the first main plane P1, and the second subportion 512 of the first beam 510 and the second subportion 522 of the second beam 520 may each extend at an angle relative to the first main plane P1.

For each of the first beam 510 and the second beam 520, the first subportion (e.g., 511 and 521) may include a first curved connecting portion, a second curved connecting portion opposite to the first curved connecting portion, and a straight body extending between the first curved connecting portion and the second curved connecting portion; the second subportion (e.g., 512 and 522) may include a straight portion and a curved portion, the straight portion extends between the curved portion and the second curved connecting portion of the first subportion; the first curved connecting portion is connected to a corresponding narrow side of the first body 501 and is curved such that the straight body is oriented in the first vertical direction Z1 and perpendicularly to the first main plane P1; the straight portion of the second subportion is located in the same plane, which is perpendicular to the longitudinal direction Y-Y, as the straight body of the first subportion, and the second curved connecting portion is curved such that the straight portion is at an acute angle relative to the straight body; and the curved portion of the second subportion extends in the same plane and is curved to form a convex contact portion having a convex surface that faces towards and contacts with the vertical subportion 203a of the intermediate portion 203 of the corresponding ground terminal 200G.

Taking the first beam 510 as an example, as shown in FIG. 5E, the first subportion 511 of the first beam 510 includes a first curved connecting portion 511a, a second curved connecting portion 511b opposite to the first curved connecting portion 511a, and a straight body 511c extending between the first curved connecting portion 511a and the second curved connecting portion 511b. The second subportion 512 includes a straight portion 512a and a curved portion 512b. The straight portion 512a of the second subportion 512 extends between the curved portion 512b and the second curved connecting portion 511b of the first subportion 511. The first curved connecting portion 511a is connected to the first narrow side 501e of the first body 501. For example, the first subportion 511 is connected to the first body 501 at the first curved connecting portion 511a and to the second subportion 512 at the second curved connecting portion 511b. The first curved connecting portion 511a is curved such that the straight body 511c is oriented in the first vertical direction Z1 and perpendicularly to the first main plane P1. The second subportion 512 may have a J shape. The straight portion 512a of the second subportion 512 is located in the same plane, which is perpendicular to the longitudinal direction Y-Y, as the straight body 511c of the first subportion 511, and the second curved connecting portion 511b is curved such that the straight portion 512a is oriented at an acute angle α relative to the straight body 511c. The angle α and an angle between the extension direction of the straight portion 512a and the first main plane P1 are complementary to each other, e.g., the sum thereof equals to 90 degrees. The curved portion 512b of the second subportion 512 extends in the same plane and is curved to form a convex contact portion having a convex surface 512c. As shown in FIG. 4H, the convex surface 512c faces towards and contacts with the vertical subportion 203a of the intermediate portion 203 of a corresponding ground terminal 200G of the first row R1. With such a configuration, it is possible for the first beam 510 to be reliably pressed against the vertical subportion 203a of the intermediate portion 203 of the corresponding ground terminal 200G of the first row R1. In some embodiments, as shown in FIG. 4H, the curved portion 512b may not extend beyond a plane defined by the first broadside 501c in the second vertical direction Z2.

In some embodiments, as shown in FIG. 4G, the ground terminals 200G of the first row R1 and the ground terminals 200G of the second row R2 may be offset from each other in the longitudinal direction Y-Y, and the plurality of first beams 510 and the plurality of second beams 520 of the first conductive member 500 may be offset from each other in the longitudinal direction Y-Y. With such a configuration, the integrity of the signal passing through the electrical connector 10 can be further improved, thereby further improving the signal transmission performance of the electrical connector 10. In some embodiments, the plurality of first beams 510 and the plurality of second beams 520 can be aligned with each other in the longitudinal direction Y-Y.

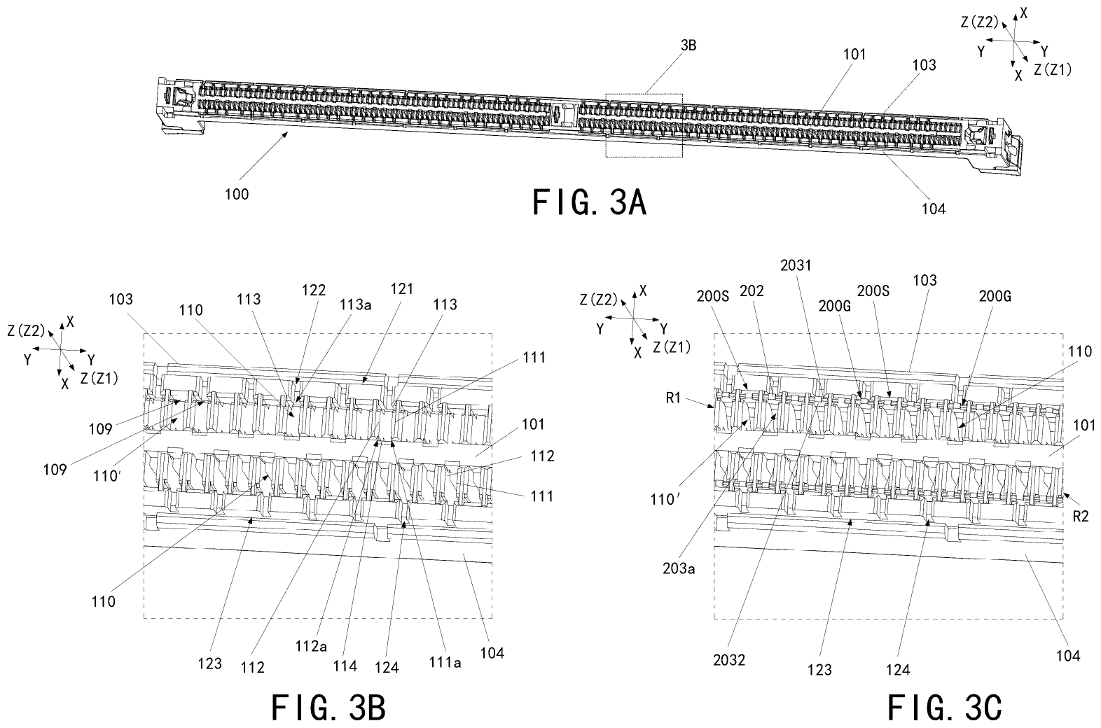

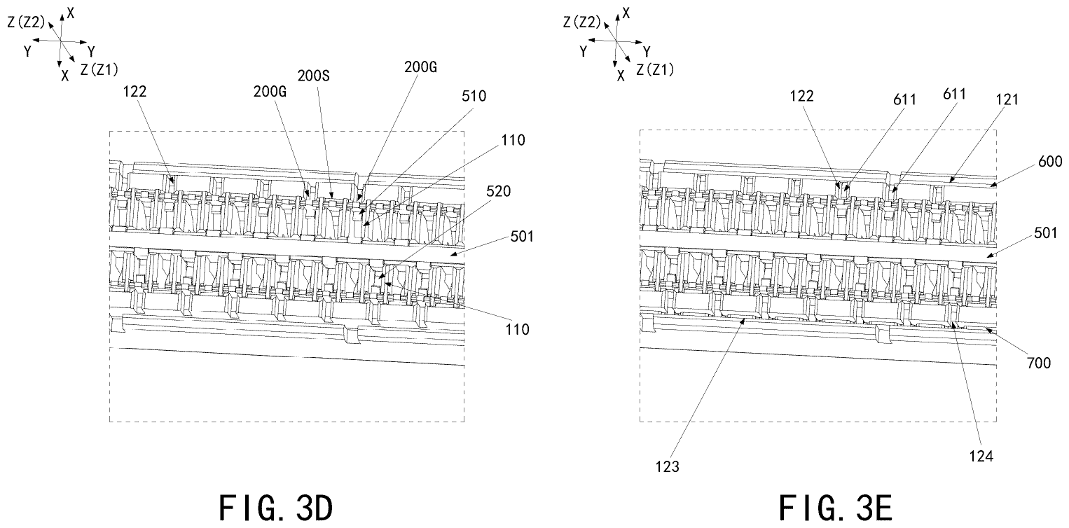

FIG. 3A is a perspective view of the insulative housing 100 of the electrical connector 10. FIG. 3B is an enlarged view of the region 3B marked by the dashed box in FIG. 3A. FIG. 3C is an enlarged view similar to FIG. 3B, but with the conductive elements 200 of the electrical connector 10 held by the insulative housing 100. FIG. 3D is an enlarged view similar to FIG. 3B, but with the conductive elements 200 and the first conductive member 500 of the electrical connector 10 held by the insulative housing 100. FIG. 3E is an enlarged view similar to FIG. 3B, but with the conductive elements 200, the first conductive member 500, the second conductive member 600, and the third conductive member 700 of the electrical connector 10 held by the insulative housing 100.

In some embodiments, as shown in FIGS. 3A and 3B, the insulative housing 100 may include a plurality of terminal channels 109 extending from the first face 101 into the insulative housing 100 in the first vertical direction Z1. The plurality of conductive elements 200 may be inserted into the insulative housing 100 via the corresponding terminal channels 109. It should be appreciated that the present application is not limited thereto. In some embodiments, the insulative housing 100 may be overmolded on the plurality of conductive elements 200, or the plurality of conductive elements 200 may be held by an insulative terminal retention member (not shown) and the terminal retention member is inserted into the insulative housing 100 to retain the plurality of conductive elements 200 in the insulative housing 100.

In some embodiments, as shown in FIGS. 3A and 3B, the insulative housing 100 may include a plurality of first channels 110 extending into the insulative housing 100 from the first face 101 in the first vertical direction Z1. Each first channel 110 may be adjacent to a terminal channel 109 corresponding to a corresponding ground terminal 200G in the lateral direction X-X. Each first channel 110 may include a first sidewall 111 and a second sidewall 112 opposite to each other in the longitudinal direction Y-Y, and a third sidewall 113 and a fourth sidewall 114 opposite to each other in the lateral direction X-X. The third sidewall 113 of each of the plurality of first channels 110 may include an opening 113a. The opening 113a may communicate the first channel 110 with the terminal channel 109 to expose at least a portion of the vertical subportion 203a of the intermediate portion 203 of a corresponding ground terminal 200G of the first row R1 and the second row R2. For example, at least the portion is exposed in the first channel 110. As shown in FIG. 3C, the conductive elements 200 are disposed in the insulative housing 100. The broadsides (surfaces) 2032 of the vertical subportions 203a of the intermediate portions 203 of the ground terminals 200G of the first row R1 and the second row R2 are exposed in the corresponding first channels 110.

FIG. 3C also illustrates that the insulative housing 100 may include a plurality of channels 110′ extending from the first face 101 into the insulative housing 100 in the first vertical direction Z1, and the vertical subportion 203a of the intermediate portion 203 of each signal terminal 200S of the first row R1 and the second row R2 is exposed in a corresponding channel 110′. However, it should be appreciated that the present application is not limited thereto. In some embodiments, the insulative housing 100 may be devoid of the channels 110′.

As shown in FIG. 3D, the conductive elements 200 and the first conductive member 500 are held by the insulative housing 100. In some embodiments, the first body 501 of the first conductive member 500 is disposed on the first face 101 of the insulative housing 100. The first broadside 501c of the first body 501 faces towards and contacts with the first face 101 of the insulative housing 100. The first broadside 501c and the first main plane P1 may be parallel to the first face 101. Each of the first beam 510 and the second beam 520 is received in a corresponding one of the plurality of first channels 110 and is resiliently pressed against the vertical subportion 203a of the intermediate portion 203 of the corresponding ground terminal 200G (FIGS. 1F and 1H). With such a configuration, it is possible to integrate the first conductive member 500 into the electrical connector 10 without significantly increasing or without increasing the dimension of the electrical connector 10 in the vertical direction Z-Z. This enables to improve the signal transmission performance of the electrical connector 10 without significantly increasing the footprint of the electrical connector 10 on the circuit board 3. In some embodiments, the insulative housing 100 may include a recess (not shown) recessed into the insulative housing 100 from the first face 101 in the first vertical direction Z1, and the first body 501 of the first conductive member 500 may be received in the recess. In this case, the first conductive member 500 may be disposed in the insulative housing 100.

In some embodiments, as shown in FIG. 3B, each first channel 110 may include a first groove 111a and a second groove 112a recessed into the insulative housing 100 from the first sidewall 111 and the second sidewall 112 in the longitudinal direction Y-Y, respectively. In one of these embodiments, the fourth sidewall 114 of the first channel 110 defines one sidewall of the first groove 111a and one sidewall of the second groove 112a. For example, the fourth sidewall 114 of the first channel 110 may provide one sidewall for the first groove 111a and one sidewall for the second groove 112a. The sidewall of the first groove 111a and the sidewall of the second groove 112a are located on the same side of the first groove 111a and the second groove 112a.

For each of the first beam 510 and the second beam 520, the first subportion (e.g., 511 and 521) may include a first side edge and a second side edge opposite to each other in the longitudinal direction Y-Y, the first side edge and the second side edge of the first subportion are received in the first groove 111a and the second groove 112a of the corresponding first channel 110, respectively. Taking the first beam 510 as an example, as shown in FIG. 5C, the first subportion 511 of the first beam 510 includes a first side edge 5111 and a second side edge 5112 opposite to each other in the longitudinal direction Y-Y. The first side edge 5111 and the second side edge 5112 of the first subportion 511 of the first beam 510 may be received in the first groove 111a and the second groove 112a of the corresponding first channel 110, respectively, when the first beam 510 is received in the corresponding first channel 110. The first side edge 5111 and the second side edge 5112 may engage with the first groove 111a and the second groove 112a, respectively, to restrict the movement of the first beam 510 relative to the insulative housing 100 in at least one of the lateral direction X-X, the longitudinal direction Y-Y, and the vertical direction Z-Z, thereby reliably retaining the first conductive member 500 in position relative to the insulative housing 100.

In one of these embodiments, for each of the first beam 510 and the second beam 520, the first subportion (e.g., 511 and 521) may include a first barb and a second barb protruding from the first side edge and the second side edge in the longitudinal direction Y-Y, respectively, the first barb and the second barb engage with a bottom wall of the first groove and a bottom wall of the second groove of the corresponding first channel, respectively. With such a configuration, the first conductive member 500 can be reliably retained in position relative to the insulative housing 100. Taking the first beam 510 as an example, as shown in FIG. 5C, the first subportion 511 of the first beam 510 includes a first barb 5113 and a second barb 5114 protruding from the first side edge 5111 and the second side edge 5112 in the longitudinal direction Y-Y, respectively. The first barb 5113 and the second barb 5114 engage with a bottom wall of the first groove 111a and a bottom wall of the second groove 112a of a corresponding first channel 110, respectively, thereby reliably retaining the first conductive member 500 in position relative to the insulative housing 100.

In some embodiments, the first conductive member 500 may be held in position relative to the insulative housing 100 only by the respective mating of the first beam 510 and the second beam 520 with the walls of the corresponding first channel. This allows for facilitating the assembly of the electrical connector 10 and reducing the cost of the electrical connector 10. Alternatively or additionally, the first conductive member 500 may have other securing feature(s) for retaining the first conductive member 500 in position relative to the insulative housing 100.

In some embodiments, as shown in FIGS. 1G and 1E, for each of the first beam 510 and the second beam 520, the first subportion (e.g., 511 and 521) is pressed against the fourth sidewall 114 of a corresponding first channel 110 when the second subportion (e.g., 512 and 522) is pressed against the vertical subportion 203a of the intermediate portion 203 of the corresponding ground terminal 200G. The first subportion (e.g., 511 and 521) abuts against the fourth sidewall 114 of the corresponding first channel 110 to provide reliable support. For example, the resilient beams are in a compression state when the first conductive member 500 is held by the insulative housing 100 to mate with the plurality of ground terminals 200G. With such a configuration, the first conductive member 500 can be reliably retained in position relative to the insulative housing 100.

In some embodiments, as shown in FIGS. 1G and 1E, for each of the plurality of conductive elements 200, the intermediate portion 203 extends out of the insulative housing 100 from the first face 101 with the tail end 202 entirely located outside of the insulative housing 100. In this case, the joint between the tail end 202 and the intermediate portion 203 may be at a first distance from the first face 101 in the vertical direction Z-Z. The second broadside 501d of the first body 501 of the first conductive member 500 defines a portion of the first conductive member 500 that is furthest away from the first face 101 in the vertical direction Z-Z. For example, the second broadside 501d is the lowest portion, e.g., the bottom, of the first conductive member 500 in the second vertical direction Z2 (the vertical downward direction). The second broadside 501d may be at a second distance from the first face 101 in the vertical direction Z-Z. The second distance may be less than or equal to the first distance. For example, the second broadside 501d does not extend beyond the joint between the tail end 202 and the intermediate portion 203 in the second vertical direction Z2. There may be a gap, e.g., no contact, between the first conductive member 500 and the surface 3a of the circuit board 3. There may be no direct electrical connection between the first conductive member 500 and the circuit board 3.

In some embodiments, the plurality of first extensions of the first conductive member 500 may be in the form of protrusions, tabs, or any other suitable form.

As shown in FIGS. 1E to 1H, 2E, 3E, and 4A to 4H, the second conductive member 600 may be disposed in the insulative housing 100. The second conductive member 600 is disposed at the second side of the first row R1, e.g., the side of the first row R1 facing away from the second row R2. The second conductive member 600 is configured for electrically coupling the plurality of ground terminals 200G of the first row R1 together by electrically coupling with the intermediate portions 203 of the plurality of ground terminals 200G of the first row R1.

With such a configuration, it is possible to provide a conductive pathway among the ground terminals 200G of the first row R1 to eliminate as much as possible potential differences among these ground terminals 200G, and to reduce the effect of crosstalk, thereby improving the integrity of the signal passing through the electrical connector 10. In the case where such a configuration is incorporated in the electrical connector 10 in conjunction with the BGA attachment and the first conductive member 500, it is possible to significantly improve the integrity of the signal passing through the electrical connector 10, thereby improving the signal transmission performance of the electrical connector 10. Furthermore, since the second conductive member 600 is configured for electrically coupling with the ground terminals 200G at the intermediate portions 203, there is no change to the layout of the tail ends 202 at the mounting interface of the electrical connector 10, and thus there is no change to the layout of the conductive pads on the circuit board 3 for establishing connections with the electrical connector 10, and there is no significant increase or even no increase in the footprint of the electrical connector 10 on the circuit board 3. This enables the electrical connector 10 to provide improved signal transmission performance while still being compatible with existing standards, for example, DDR standards such as DDR4 or DDR5. In addition, this enables the electrical connector 10 to meet the performance requirements specified by higher DDR standards.

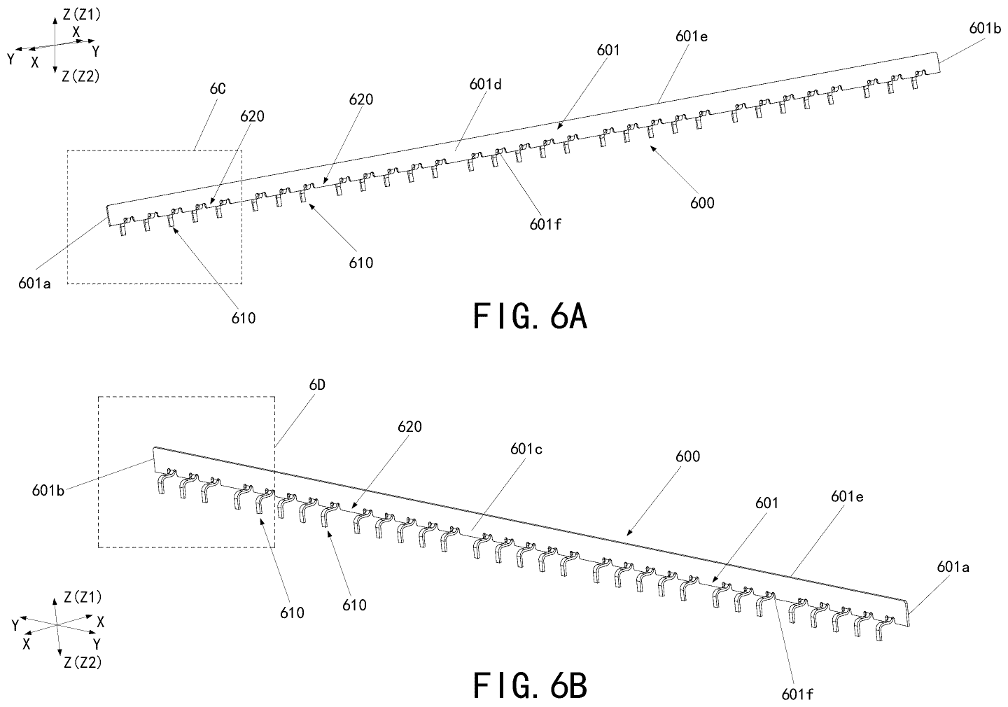

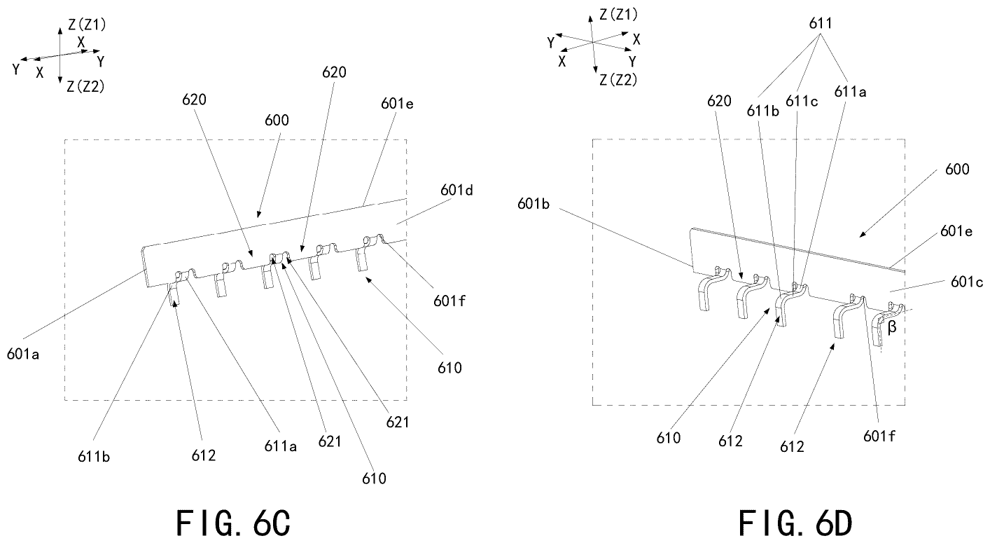

FIGS. 6A to 6D illustrate an exemplary type of the second conductive member 600 in detail. As shown in FIGS. 6A to 6D, the second conductive member 600 may include a second body 601 and a plurality of second extensions. The second body 601 may be elongated in the longitudinal direction Y-Y. Each of the plurality of second extensions may extend from the second body 601 towards a corresponding ground terminal 200G of the first row R1 to be in direct contact with or capacitively coupled with the intermediate portion 203 of the corresponding ground terminal 200G. With such a configuration, the second conductive member 600 may be electrically coupled with the corresponding ground terminals 200G of the first row R1 through the plurality of second extensions and electrically couple the ground terminals 200G of the first row R1 together through the second body 601.

In some embodiments, the second conductive member 600 may be formed from a metallic material such as copper. In such embodiments, each second extension of the second conductive member 600 may be in direct contact with the intermediate portion 203 of the corresponding ground terminal 200G. In some embodiments, the second conductive member 600 may be formed from a lossy material. In this case, each second extension of the second conductive member 600 may be in direct contact with or capacitively coupled to the intermediate portion 203 of the corresponding ground terminal 200G.

As shown in FIGS. 4H and 6A to 6D, the second body 601 of the second conductive member 600 may be in a shape of a flat plate and may extend in a second main plane P2 perpendicular to the lateral direction X-X. The second body 601 may include a third end 601a and a fourth end 601b opposite to each other in the longitudinal direction Y-Y, a fifth broadside 601c and a sixth broadside 601d opposite to each other in the lateral direction X-X, and a fifth narrow side 601e and a sixth narrow side 601f opposite to each other in the vertical direction Z-Z. The second body 601 may be continuously flat in the longitudinal direction Y-Y and the vertical direction Z-Z. The broadsides of the second body 601 may also be referred to as “surfaces” of the second body 601, and the narrow sides of the second body 601 may also be referred to as “side edges” of the second body 601. As shown in FIG. 4H, the second main plane P2 may be centered between the fifth broadside 601c and the sixth broadside 601d, and may be parallel to the fifth broadside 601c and the sixth broadside 601d. The second main plane P2 may be defined by a major extension direction of the second body 601. The second main plane P2 may also be referred to as “a center plane” or “an extension plane” of the second body 601. As shown in FIGS. 4E to 4H, when the second conductive member 600 is disposed in the insulative housing 100, the fifth broadside 601c of the second body 601 faces towards the first row R1 and the sixth broadside 601d faces away from the first row R1, and the fifth narrow side 601e of the second body 601 faces towards the first vertical direction Z1 and the sixth narrow side 601f faces towards from the second vertical direction Z2. Furthermore, the second main plane P2 is perpendicular to the lateral direction X-X. For example, the second conductive member 600 is oriented in such a manner that the second main plane P2 of the second body 601 is perpendicular to the lateral direction X-X.

With such configuration and orientation of the second conductive member 600, it is possible to provide shielding for the signal terminals 200S of the first row R1, thereby improving the integrity of the signal passing through the electrical connector 10. This enables to improve the signal transmission performance of the electrical connector 10. Furthermore, such a configuration does not significantly increase the dimension of the electrical connector 10 in the lateral direction X-X. This enables to improve the signal transmission performance of the electrical connector 10 without significantly increasing the footprint of the electrical connector 10 on the circuit board 3. The second conductive member 600 may also be referred to as “a shielding” or “a shield”.

With reference to FIGS. 6A to 6D, the plurality of second extensions of the second conductive member 600 may be in the form of beams (or arms). The plurality of second extension portions may include a plurality of third beams 610. Each of the plurality of third beams 610 may extend from the sixth narrow side 601f of the second body 601 towards a corresponding ground terminal 200G of the first row R1 to be in direct contact with the vertical subportion 203a of the intermediate portion 203 of the corresponding ground terminal 200G. With such a configuration, the second conductive member 600 may be in direct contact with the corresponding ground terminals 200G of the first row R1 through the third beams 610 and electrically connect the ground terminals 200G of the first row R1 together through the second body 601.

In some embodiments, as shown in FIGS. 4H, 6C, and 6D, each of the third beams 610 may include a third subportion 611 and a fourth subportion 612. The third subportion 611 extends from the sixth narrow side 601f of the second body 601 in the lateral direction X-X towards a corresponding ground terminal 200G of the first row R1. The fourth subportion 612 extends from the third subportion 611 in the second vertical direction Z2 and is disposed on the vertical subportion 203a of the intermediate portion 203 of the corresponding ground terminal 200G. In some examples, the fourth subportion 612 may be secured on the vertical subportion 203a of the corresponding ground terminal 200G. In some other examples, instead of being secured on the vertical subportion 203a, the fourth subportion 612 may be (e.g., resiliently) pressed against the vertical subportion 203a of the corresponding ground terminal 200G.

As shown in FIG. 6D, the third subportion 611 of the third beam 610 may include a third curved connecting portion 611a, a fourth curved connecting portion 611b opposite to the third curved connecting portion 611a, and a straight body 611c extending between the third curved connecting portion 611a and the fourth curved connecting portion 611b. The third curved connecting portion 611a is connected to the sixth narrow side 601f of the second body 601. The fourth subportion 612 may be straight and extend from the fourth curved connecting portion 611b of the third subportion 611. For example, the third subportion 611 is connected to the second body 601 at the third curved connecting portion 611a and to the fourth subportion 612 at the fourth curved connecting portion 611b. The third curved connecting portion 611a is curved such that the straight body 611c of the third subportion 611 is oriented in the lateral direction X-X. The straight body 611c of the third subportion 611 is disposed in the same plane, which is perpendicular to the longitudinal direction Y-Y (e.g., perpendicular to the second main plane P2), as the fourth subportion 612, and the fourth curved connecting portion 611b is curved such that the fourth subportion 612 is oriented at a right angle β relative to the straight body 611c. The third subportion 611 of the third beam 610 may extend perpendicularly to the plane P2, and the fourth subportion 612 may extend parallelly to the plane P2.

As shown in FIGS. 1F and 3B, the insulative housing 100 may include a first receiving groove 121 and a plurality of second channels 122 extending into the insulative housing 100 from the first face 101 in the first vertical direction Z1, respectively. The vertical subportion 203a of the intermediate portion 203 of each ground terminal 200G of the first row R1 may be exposed in a corresponding one of the plurality of second channels 122. As shown in FIG. 3C, the broadside (surface) 2031 of the vertical subportion 203a of the ground terminal 200G opposite to the broadside 2032 may be exposed in a corresponding second channel 122. As shown in FIGS. 1F and 3E, the second body 601 of the second conductive member 600 is received in the first receiving groove 121, and each of the plurality of third beams 610 is received in a corresponding one of the plurality of second channels 122, and the fourth subportion 612 is disposed on the vertical subportion 203a of the intermediate portion 203 of the corresponding ground terminal 200G. With such a configuration, it is possible to integrate the second conductive member 600 into the electrical connector 10 without significantly increasing the dimension of the electrical connector 10 in the lateral direction X-X. This enables to improve the signal transmission performance of the electrical connector 10 without significantly increasing the footprint of the electrical connector 10 on the circuit board 3. In addition, such a configuration enables to increase the manufacturing efficiency of the electrical connector 10 and reduce the manufacturing cost thereof.

In some embodiments, as shown in FIGS. 6C and 6D, the fourth subportion 612 of each of the plurality of third beams 610 may extend beyond the sixth narrow side 601f of the second body 601 in the second vertical direction Z2. As shown in FIGS. 1F and 3B, each of the plurality of second channels 122 may extend through the insulative housing 100 to the outside of the insulative housing 100 in the lateral direction X-X, so as to allow the fourth subportion 612 of the third beam 610 that is received in the second channel 122 to be accessible from the outside of the insulative housing 100 via the corresponding second channel 122. With such a configuration, the fourth subportion 612 of the third beam 610 can be welded to the corresponding ground terminal 200G by using welding means such as laser welding after the second conductive member 600 is inserted into the insulative housing 100. In this case, the fourth subportion 612 of each of the plurality of third beams 610 is attached on the vertical subportion 203a of the intermediate portion 203 of the corresponding ground terminal 200G by welding. The attachment may be via a line weld along the fourth subportion 612 in the vertical direction Z-Z. The line weld may be greater than 60%, 70%, 80%, or 90% of the length of the fourth subportion 612 in the vertical direction Z-Z. The line weld may have an aspect ratio of length to width greater than 2:1, e.g., in some examples, the aspect ratio may be greater than 5:1 or greater than 10:1.

With such a configuration, the third beams 610 can be reliably connected to the corresponding ground terminals 200G, thereby reliably retaining the second conductive member 600 and the ground terminals 200G of the first row R1 in position relative to each other. Furthermore, since each third beam 610 of the second conductive member 600 is received in a corresponding second channel 122, the accuracy and speed of connecting the second conductive member 600 to the ground terminals 200G of the first row R1 can be increased. In addition, since the second body 601 of the second conductive member 600 is received in the first receiving groove 121 of the insulative housing 100, it can thus help to reliably retain the ground terminals 200G of the first row R1 in the insulative housing 100.

As described above, for each conductive element 200, the tail end 202 may extend from the vertical subportion 203a of the intermediate portion 203. In some embodiments, as shown in FIG. 1F, the fourth subportion 612 of each of the plurality of third beams 610 does not extend, in the second vertical direction Z2, beyond the joint between the tail end 202 and the vertical subportion 203a. For example, the fourth subportion 612 is not in contact with the solder ball 400. In some embodiments, the fourth subportion 612 may extend beyond the joint between the tail end 202 and the vertical subportion 203a in the second vertical direction Z2 to be connected to the conductive pad 3b of the circuit board 3 via the solder ball 400 together with the tail end 202.

The first row R1 may have a first length in the longitudinal direction Y-Y. The second body 601 of the second conductive member 600 may have a second length in the longitudinal direction Y-Y between third end 601a and the fourth end 601b. In some embodiments, as shown in FIGS. 4E to 4G, this second length of the second body 601 may be equal to or greater than the first length of the first row R1. With such a configuration, the second body 601 may provide shielding for the entire first row R1. In some embodiments, the second length of the second body 601 may be less than the first length of the first row R1.

As described above, for the first row R1, the intermediate portion 203 of each conductive element 200 may include the vertical subportion 203a and the inclined subportion 203b that is inclined from the vertical subportion 203a relative to the vertical direction Z-Z towards the second row R2. The inclined subportion 203b connects the vertical subportion 203a and the mating end 201, and the tail end 202 extends from the vertical subportion 203a oppositely to the inclined subportion 203b. In some embodiments, an extension range of the second body 601 in the vertical direction Z-Z may cover at least a portion of the inclined subportion 203b of the intermediate portion 203 of the conductive element 200 of the first row R1. With such a configuration, the second conductive member 600 can provide shielding along the signal transmission path in the electrical connector 10, thereby improving the integrity of the signal passing through the electrical connector 10 and thus improving the signal transmission performance of the electrical connector 10. For example, the extension range of the second body 601 in the vertical direction Z-Z can cover the entire inclined subportion 203b of the intermediate portion 203 of the conductive element 200 of the first row R1.

In some embodiments, as shown in FIG. 6C, the second conductive member 600 may include a plurality of third extensions 620 extending from the sixth narrow side 601f of the second body 601 in the second vertical direction Z2. The plurality of third extensions 620 separate the plurality of third beams 610 from each other, with a third extension 620 located between every two adjacent third beams 610. Each of the plurality of third extensions 620 is separated from each of adjacent two third beams 610 by a gap. As shown in FIG. 4H, each of the plurality of third extensions 620 corresponds to a corresponding (e.g., a single or a pair of) signal terminal(s) 200S of the first row R1 in the lateral direction X-X and covers at least a portion of the vertical subportion 203a of the intermediate portion 203 of the corresponding signal terminal 200S in the second vertical direction Z2. With such a configuration, the second conductive member 600 can provide shielding along the signal transmission path in the electrical connector 10, thereby improving the integrity of the signal passing through the electrical connector 10 and improving the signal transmission performance of the electrical connector 10. For example, the third extension 620 may cover the entire length of the vertical subportion 203a in the vertical direction Z-Z, or cover 30%, 50%, 70%, 90%, or any value therebetween of the length of the vertical subportion 203a in the vertical direction Z-Z. For example, the third extension 620 may extend in the second vertical direction Z2 to align with the joint between the vertical subportion 203a and the tail end 202. In some examples, the third extension 620 may extend beyond the first face 101 of the insulative housing 100 in the second vertical direction Z2.

In some embodiments, as shown in FIGS. 1F and 4H, the first conductive member 500 is electrically coupled to the intermediate portion 203 at a first position of the intermediate portion 203 of the ground terminal 200G of the first row R1, and the second conductive member 600 is electrically coupled to the intermediate portion 203 at a second position of the intermediate portion 203 of the ground terminal 200G of the first row R1, the first position and the second position are located on two sides of the intermediate portion 203 opposite to each other in the lateral direction X-X (e.g., the two broadsides 2031 and 2032 of the vertical subportion 203a), respectively, and at least partially overlap with each other in the lateral direction X-X. With such a configuration, the integrity of the signal passing through the electrical connector 10 can be further improved, thereby further improving the signal transmission performance of the electrical connector 10. In some embodiments, the first position and the second position may be offset from each other. For example, the first position may be higher or lower than the second position in the first vertical direction Z1 (in the vertical upward direction).

In some embodiments, the third beam 610 may be in the form of a resilient beam similar to the first beam 510 and the second beam 520 and may be resiliently pressed against the intermediate portion 203 of the corresponding ground terminal 200G. In some embodiments, the plurality of second extensions of the second conductive member 600 may also be in the form of protrusions, tabs, or any other suitable forms.

As shown in FIGS. 4F and 4G, the (single or pair of) signal terminal(s) 200S of the first row R1 may be surrounded by the ground terminals 200G, the first body 501 and the first beams 510 of the first conductive member 500, and the second body 601 and the third beams 610 of the second conductive member 600. The ground terminals 200G, the first conductive member 500, and the second conductive member 600 can together form a shielding mechanism surrounding the signal terminal(s) 200S. With such a configuration, the integrity of the signal passing through the electrical connector 10 can be improved, thereby improving the signal transmission performance of the electrical connector 10.

As shown in FIGS. 1E to 1H, 2E, and 4A to 4H, the third conductive member 700 may be disposed in the insulative housing 100. The third conductive member 700 is disposed at the fourth side of the second row R2, e.g., the side of the second row R2 facing away from the first row R1. The detailed configurations and functions of the third conductive member 700 are the same as the aforementioned configurations and functions of the second conductive member 600. Similar to the second conductive member 600, the third conductive member 700 is configured for electrically coupling the plurality of ground terminals 200G of the second row R2 together by electrically coupling with the intermediate portions 203 of the plurality of ground terminals 200G of the second row R2. The third conductive member 700 may have a body and beams similar to the second body 601 and the third beams 610 of the second conductive member 600, respectively. The insulative housing 100 may have a receiving groove 123 and channels 124 (FIGS. 1H, 3B, 3C, and 3E) similar to the first receiving groove 121 and the second channels 122, so as to receive the body and beams of the third conductive member 700. The configurations and functions of the third conductive member 700 will not be repeated herein.

Similarly, the ground terminals 200G of the plurality of conductive elements 200, the first conductive member 500, the second conductive member 600, and the third conductive member 700 can together form a shielding mechanism surrounding the signal terminals 200S. With such a configuration, the integrity of the signal passing through the electrical connector 10 can be improved, thereby improving the signal transmission performance of the electrical connector 10.

The inventors have also recognized and appreciated a method for manufacturing the electrical connector 10.

The method may include disposing the plurality of conductive elements 200 in the insulative housing 100 (FIG. 3C). In some embodiments, this may be accomplished by inserting the plurality of conductive elements 200 into corresponding terminal channels 109. In some embodiments, this may be accomplished by overmolding the insulative housing 100 on the plurality of conductive elements 200. In some embodiments, this may be accomplished by inserting a terminal retention member (not shown), which holds the plurality of conductive elements 200, into the insulative housing 100.

The method may also include mounting the first conductive member 500 to the insulative housing 100 in the manner as described above (FIGS. 1F, 1H, and 3D) to electrically couple the ground terminals 200G of the first row R1 and the ground terminals 200G of the second row R2 together.

Alternatively or additionally, the method may also include disposing the second conductive member 600 in the insulative housing 100 in the manner as described above (FIGS. 1F and 3E) to electrically couple the plurality of ground terminals 200G of the first row R1 together. In some embodiments, the method may include welding the third beams 610 of the second conductive member 600 to the intermediate portions 203 of the corresponding ground terminals 200G via the second channels 122.

Alternatively or additionally, the method may also include disposing the third conductive member 700 in the insulative housing 100 in the manner as described above (FIGS. 1H and 3E) to electrically couple the plurality of ground terminals 200G of the second row R2 together.

Alternatively or additionally, the method may also include attaching the solder balls 400 to the tail ends 202 of the plurality of conductive elements 200 in the manner as described above.

Although each of the first conductive member 500, the second conductive member 600, and the third conductive member 700 is shown as a single-piece monolithic structure, it should be appreciated that In some embodiments, one or more of the first conductive member 500, the second conductive member 600, and the third conductive member 700 may be a multi-piece structure.

Although described above is the situation in which the first conductive member 500, the second conductive member 600, and the third conductive member 700 are used in combination, it should be appreciated that In some embodiments, the first conductive member 500, the second conductive member 600, and the third conductive member 700 may be used individually or in any suitable combination to provide one or more of the aforementioned benefits.

Although described above is the situation in which the plurality of conductive elements 200 are directly disposed in the insulative housing 100, it should be appreciated that in some embodiments, an insulative terminal retention member may be overmolded on the plurality of conductive elements 200 to retain the plurality of conductive elements 200 in position relative to one another, thereby forming a terminal subassembly. The terminal subassembly may then be inserted into the insulative housing 100 to retain the plurality of conductive elements 200 in the insulative housing 100. One or more of the first conductive member 500, the second conductive member 600, and the third conductive member 700 may be disposed on or in the terminal subassembly and be inserted into the insulative housing 100 together with the terminal subassembly.

Although described above is the situation in which the plurality of conductive elements 200 are arranged in two rows, it should be appreciated that in some embodiments, the plurality of conductive elements 200 are arranged in a single row or more than two (e.g., four) rows. In this case, one or more of the first conductive member 500, the second conductive member 600, and the third conductive member 700 may still be electrically coupled with the plurality of conductive elements 200 to provide the aforementioned benefits.

Although described above is the situation in which the tail ends 202 of the plurality of conductive elements 200 are connected to the conductive pads of the circuit board via BGA attachment, it should be appreciated, and as will be described below, that in other embodiments, the tail ends 202 of the plurality of conductive elements 200 may be connected to corresponding conductive structures of the circuit board via any other suitable attachment method, such as via any other Surface Mounting Technology (SMT) or Through-Hole Technology (THT). In this case, one or more of the first conductive member 500, the second conductive member 600, and the third conductive member 700 may still be electrically coupled with the plurality of conductive elements 200 to provide the aforementioned benefits.

Although described above is the situation in which the electrical connector 10 is configured as a vertical card edge connector, it should be appreciated that in some embodiments, the electrical connector 10 may be configured as any other suitable type of connector, such as a right-angle electrical connector.

Although described above is the situation in which the electrical connector 10 is configured for receiving a memory card, it should be appreciated that in some embodiments, the electrical connector 10 may be configured for mating with any other suitable type of electrical component, such as any other type of add-in card or another electrical connector (e.g., a plug connector).

Some of the conductive elements in a row may be used as high-speed signal conductors. Optionally, some of the conductive elements may be used as low-speed signal conductors or power conductors. Some of the low-speed signal conductors and/or power conductors may also be designated as ground to give reference to the signals being carried on the signal conductors or to provide a return path for those signals. It should be appreciated that the ground conductor does not need to be connected to earth ground, but may carry a reference potential, which may include earth ground, DC voltage or other suitable reference potential.

Although described above is the situation in which high-speed and low-speed signal conductors may be configured the same, with signal conductors in the same row having the same shape. The high-speed and low-speed signal conductors nonetheless may be differentiated based on the ground structures and insulative portions around them. Alternatively, some or all of the high-speed signal conductors may be configured differently from low-speed signal conductors, even within the same row. The edge-to-edge spacing may be closer for high-speed signal conductors, for example.

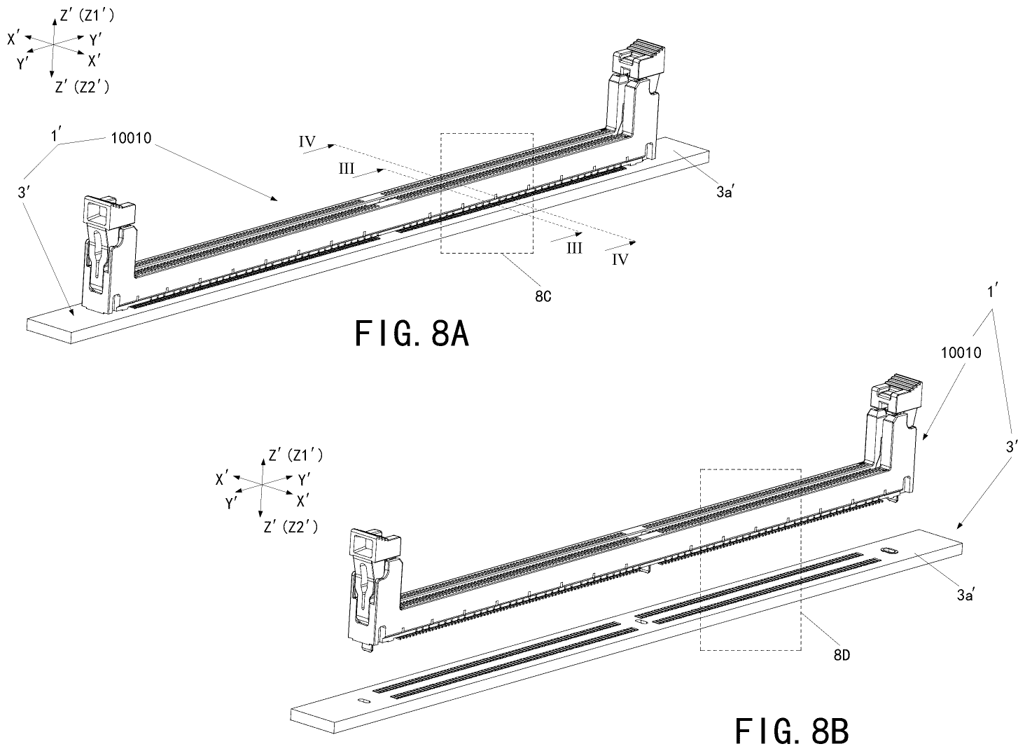

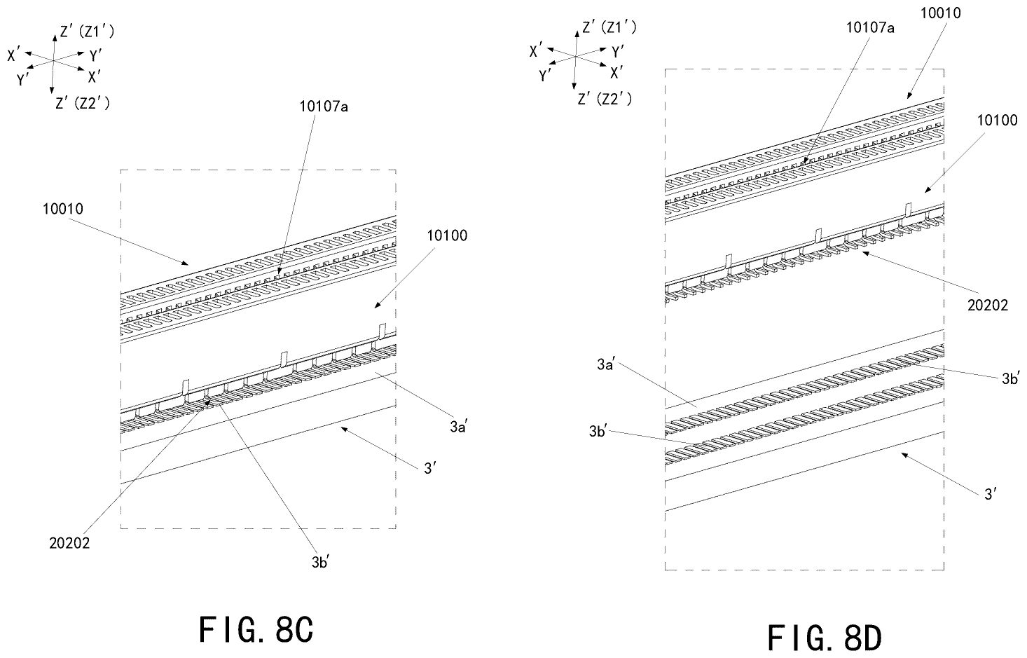

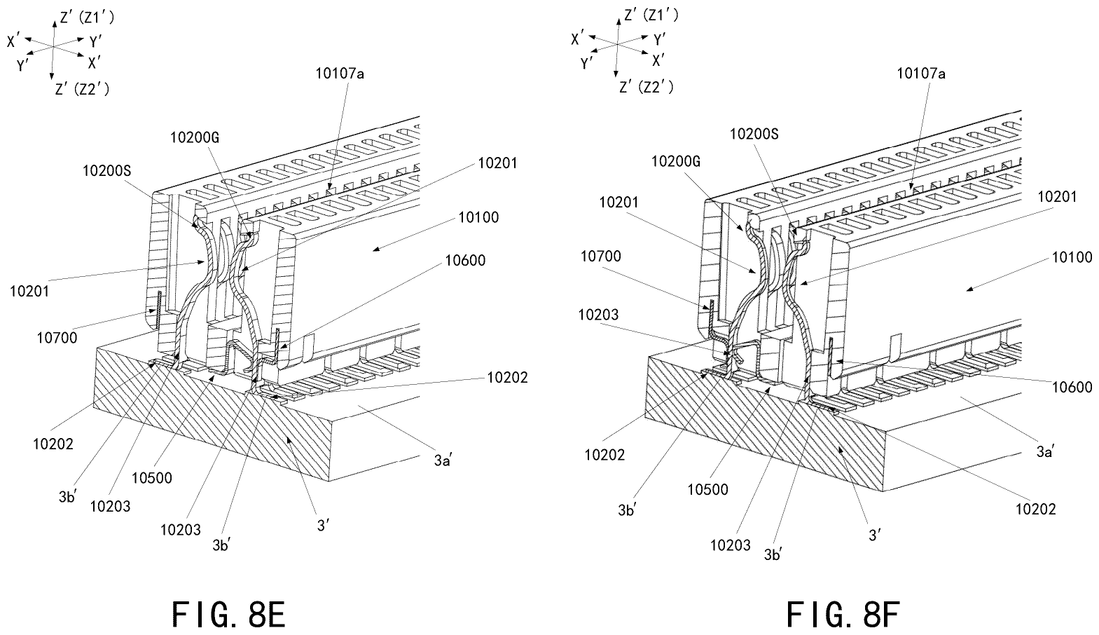

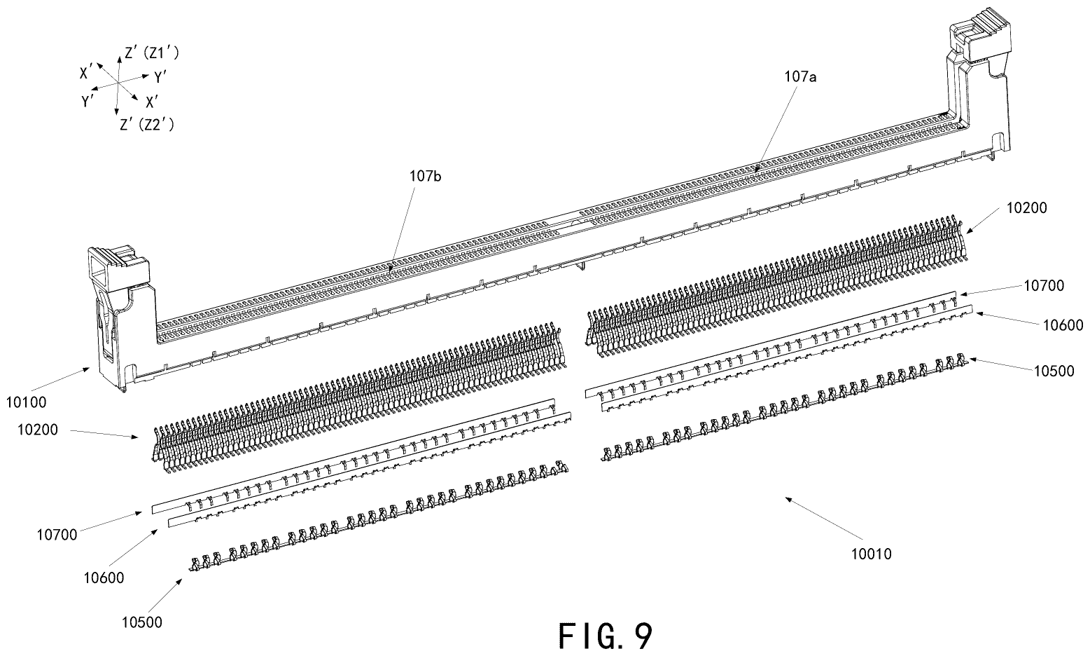

According to aspects of the present disclosure, FIGS. 8A to 9 illustrate an electronic system 1′ according. Similar to the electronic system 1 shown in FIGS. 1A to 1H, the electronic system 1′ includes at least an electrical connector 10010 and a circuit board 3′.

For the sake of clarity and conciseness of the description, a lateral direction X′-X′, a longitudinal direction Y′-Y′ and a vertical direction Z′-Z′ may be shown in FIGS. 8A to 9. The lateral direction X′-X′, the longitudinal direction Y′-Y′ and the vertical direction Z′-Z′ may be perpendicular to each other. The lateral direction X′-X′ may refer to a width direction of the electrical connector 10010. The longitudinal direction Y′-Y′ may refer to a length direction of the electrical connector 10010. The vertical direction Z′-Z′ may refer to a height direction of the electrical connector 10010. The vertical direction Z′-Z′ includes a first vertical direction Z1′ oriented in the vertical direction Z′-Z′, and a second vertical direction Z2′ oriented in the vertical direction Z′-Z′ and opposite to the first vertical direction Z1′. For example, the first vertical direction Z1′ and the second vertical direction Z2′ are parallel to the vertical direction Z′-Z′ and are opposite to each other. The first vertical direction Z1′ may also be referred to as “a vertical upward direction”, and the second vertical direction Z2′ may also be referred to as “a vertical downward direction”. It should be appreciated that “upward” and “downward” are relative concepts, rather than absolute concepts.

The electrical connector 10010 is configured for establishing an electrical connection between the circuit board 3′ and another electrical component (not shown). As shown in FIGS. 8A, 8C, 8E, and 8F, the electrical connector 10010 is mounted to the circuit board 3′ and is ready to establish a separable connection with another electrical component, thereby mechanically and electrically connecting the electrical component to the circuit board 3′. The electrical component may be, for example, another circuit board or another electrical connector.

Similar to the electrical connector 10 shown in FIGS. 1A to 7C, the electrical connector 10010 may also be configured as a memory card connector to be used in a computer device. In this case, the circuit board 3′ may be a motherboard of the computer device, and the electrical component may be a memory card. The electrical connector 10010 may provide an interface that meets DDR specifications of DDR4, DD5, and higher performance requirements. The electrical connector 10010 may also be referred to as “a card edge connector”.

The configuration of the circuit board 3′ is substantially similar to the configuration of the circuit board 3 shown in FIGS. 1A to 1H. The circuit board 3′ may include a surface 3a′ and a plurality of conductive pads 3b′ disposed on the surface 3a′. The plurality of conductive pads 3b′ of the circuit board 3′ may be arranged on the surface 3a′ in two pad rows each extending in the longitudinal direction Y′-Y′ and spaced apart from each other.

Unlike the circuit board 3 shown in FIGS. 1A to 1H, the plurality of conductive pads 3b′ of the circuit board 3′ are configured to be suitable for establishing electrical connections with conductive elements of the electrical connector 10010 when the electrical connector 10010 is mounted to the circuit board 3′ by using other SMT techniques such as wave soldering, ultrasonic soldering, laser welding, and the like, as will be described below. The conductive elements of the connector 10010 establish an electrical connection, which will be specifically described below.

Each conductive pad 3b′ may have a rectangular shape. However, it should be appreciated that the shape of the conductive pads 3b′ is not limited thereto and may have any other shapes. It should also be appreciated that only a portion of the circuit board 3′ is schematically shown in the drawings, rather than the entire circuit board 3′ and that the specific type of the circuit board 3′ is not limited thereto.

As shown in FIG. 9, the configurations of the electrical connector 10010 are similar to the configurations of the electrical connector 10 shown in FIGS. 1A to 7C. Thus, for components or portions of the electrical connector 10010 that are the same as or similar to those of the electrical connector 10, the identical or similar components or portions of the electrical connector 10010 will be labeled in FIGS. 8A to 9 by adding “10,000 (ten thousand)” to the reference signs in FIGS. 1A to 7C that labels the components or portions of the electrical connector 10. For the sake of brevity, the details of these identical or similar components or portions will not be repeated.

Similar to the electrical connector 10, the electrical connector 10010 includes an insulative housing 10100, a plurality of conductive elements 10200 disposed in the insulative housing 10100, a fourth conductive member 10500 held by the insulative housing 10100, and a fifth conductive member 10600 and a sixth conductive member 10700 disposed in the insulative housing 10100. The fourth conductive member 10500 may also be referred to as “a GND bar”, and the fifth conductive member 10600 and the sixth conductive member 10700 may also be referred to as “shielding plates” or a “shields”.

Similar to the insulative housing 100 of the electrical connector 10, the insulative housing 10100 of the electrical connector 10010 may include a first slot 10107a and a second slot 10107b. FIG. 9 illustrates in detail the configurations of the electrical connector 1010 at the first slot 10107a and the second slot 10107b. As shown in FIG. 9, the plurality of conductive elements 10200 includes a first portion disposed in the first slot 10107a and a second portion disposed in the second slot 10107b. The electrical connector 10010 includes a plurality of conductive elements 10200 disposed in the first slot 10107a of the insulative housing 10100 and a fourth conductive member 10500, a fifth conductive member 10600, and a sixth conductive member 10700 associated with these conductive elements 10200. Also, as shown in FIG. 9, the configurations of the electrical connector 10010 at the second slot 10107b may be similar to the configuration thereof at the first slot 10107b. Thus, the identical or similar components of the electrical connector 10010 are labeled in FIG. 9 with the same reference signs, and for the sake of brevity, details of these identical or similar components will not be repeated.

As shown in FIGS. 8C to 9, the configurations of the conductive elements 10200 of the electrical connector 10010 are similar to the configurations of the conductive elements 200 of the electrical connector 10. Each conductive element 10200 may include a mating end 10201, a tail end 10202 opposite to the mating end 10201, and an intermediate portion 10203 extending between the mating end 10201 and the tail end 10202. The configurations of the mating end 10201 and the intermediate portion 10203 of the conductive element 10200 may be the same as the configurations of the mating end 201 and the intermediate portion 203 of the conductive element 200, respectively. Thus, for the sake of brevity, those details included above will not be repeated. The conductive elements 10200 of the electrical connector 10010 include signal terminals 10200S and 10200G (FIGS. 8E and 8F).

The conductive element 10200 differs from the conductive element 200 in that the tail ends 10202 of the conductive elements 10200 are configured to be suitable to be attached to a corresponding conductive pad 3b′ of the circuit board 3′ by using other SMT techniques such as wave soldering, ultrasonic soldering, laser soldering, and the like, rather than by BGA attachment. The electrical connector 10010 is devoid of the solder balls 400 as described above.

In particular, the tail end 10202 of the conductive element 10200 may be curved relative to the intermediate portion 10203 so as to be placed onto the conductive pad 3b′ of the circuit board 3′. For example, when the electrical connector 10010 is mounted to the circuit board 3′, a solder paste may first be applied on the conductive pads 3b′ of the circuit board 3′, and then the electrical connector 10010 is placed onto the circuit board 3′ with the tail ends 10202 of the conductive elements 10200 positioned on the corresponding conductive pads 3b′ of the circuit board 3′. The solder paste may then be heated (e.g., by placing the electrical connector 10010 and the circuit board 3′ in a reflow oven) and melted to adhere to the tail ends 10202 of the conductive elements 10200, while the solder paste remains adhered to the conductive pads 3b′. After the solder paste has cooled, the tail ends 10202 are attached and secured to the conductive pads 3b′ by the solder paste. As another example, the tail ends 10202 of the conductive elements 10200 may be connected directly to the corresponding conductive pads 3b′ of the circuit board 3′ by laser welding or ultrasonic welding. By any of these means, reliable electrical connections can be established between the electrical connector 10010 and the circuit board 3′.

As shown in FIGS. 8E to 9, the fourth conductive member 10500, the fifth conductive member 10600, and the sixth conductive member 10700 of the electrical connector 10010 may have the same structures as the first conductive member 500, the second conductive member 600, and the third conductive member 700 of the electrical connector 10, respectively. Although there are differences between the conductive elements 10200 of the electrical connector 10010 and the conductive elements 200 of the electrical connector 10 in terms of the structure and the attachment method with conductive pad, the fourth conductive member 10500, the fifth conductive member 10600, and the sixth conductive member 10700 of the electrical connector 10010 may be arranged and coupled in the same way with respect to the conductive elements 10200 as the first conductive member 500, the second conductive member 600, and the third conductive member 700 of the electrical connector 10 with respect to the conductive elements 200, respectively. For the sake of brevity, those details included above will not be repeated.

By incorporating the fourth conductive member 10500, the fifth conductive member 10600, and the sixth conductive member 10700 into the electrical connector 10010 shown in FIGS. 8A to 9, it is possible to provide the benefits that are the same as those described above in connection with the first conductive member 500, the second conductive member 600, and the third conductive member 700 of the electrical connector 10. For example, by disposing the fourth conductive member 10500, the insertion loss (IL) and the return loss (RL) of the signal passing through the electrical connector 10 can be reduced, thereby improving the integrity of the signal passing through the electrical connector 10. As another example, by disposing the fifth conductive member 10600 and/or the sixth conductive member 10700, it is possible to reduce the effects of crosstalk and provide shielding along the signal transmission path, thereby improving the integrity of the signal passing through the electrical connector. For the sake of brevity, those details included above will not be repeated. It should be appreciated that the fourth conductive member 10500, the fifth conductive member 10600, and the sixth conductive member 10700 may be used individually or in any combination to provide the benefits described above.

Although described above is the situation in which the conductive elements are coupled to conductive pads of the circuit board via SMT technology, it should be appreciated, and as will be described below, that in some embodiments, the tail ends of the conductive elements may be coupled to corresponding conductive structures of the circuit board via any other suitable attachment means, such as THT technology. In this case, one or more of the conductive members described above may still be electrically coupled with the conductive elements to provide the aforementioned benefits.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest so that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions may also be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held collectively in any other suitable way. The layers may be of the desired shape before being secured to one another or may be stamped or otherwise shaped after they are held collectively. As a further alternative, lossy portions may be formed by plating plastic or other insulative material with a lossy coating, such as a diffuse metal coating.

Although details of specific configurations of conductive elements and housings are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques as described herein may be embodied in card edge connectors or connectors configured only for high-speed signals.

As another example, high-speed and low-speed signal terminals may be configured the same, with signal terminals in the same row having the same shape. The high-speed and low-speed signal terminals nonetheless may be differentiated based on the ground structures and insulative portions around them. Alternatively, some or all of the high-speed signal terminals may be configured differently from low-speed signal terminals, even within the same row. The edge-to-edge spacing may be closer for high-speed signal terminals, for example.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An electrical connector, comprising:
a housing comprising a mating face, a mounting face, and a slot recessed from the mating face;
a plurality of conductive elements held by the housing in first and second rows separated by the slot, each of the plurality of conductive elements comprising a mating end curving into the slot, a tail end extending out of the housing at the mounting face, and an intermediate portion between the mating end and the tail end, each of the first and second rows comprising signal terminals and ground terminals disposed between the signal terminals; and
a conductive member electrically coupling the ground terminals in the first and second rows of conductive elements, the conductive member comprising a planar body disposed between the first and second rows of conductive elements, the planar body having:
a first edge facing the first row of conductive elements,
a second edge facing the second row of conductive elements, and
a broadside facing the mating face and joining the first and second edges.

2. The electrical connector of claim 1, wherein:
the conductive member is configured to reduce both insertion loss and return loss for the electrical connector.

3. The electrical connector of claim 1, wherein:
the planar body of the conductive member is disposed adjacent the mounting face of the housing.

4. The electrical connector of claim 1, wherein the conductive member comprises:
a plurality of first beams extending from the first edge of the planar body towards respective ground terminals in the first row; and
a plurality of second beams extending from the second edge of the planar body towards respective ground terminals in the second row.

5. The electrical connector of claim 4, wherein:
the slot is elongated in a first direction; and
the plurality of first beams and the plurality of second beams are offset from each other in the first direction.

6. The electrical connector of claim 4, wherein each of the plurality of first beams comprises:
a first subportion extending from the first edge of the planar body in a direction perpendicular to the planar body; and
a second subportion extending from the first subportion away from the first edge towards the respective ground terminal in the first row and configured to contact the intermediate portion of the respective ground terminal in the first row.

7. The electrical connector of claim 6, wherein:
the housing comprises a plurality of first channels recessed into the housing from the mounting face in the direction perpendicular to the planar body; and
each of the plurality of first beams is disposed in a respective one of the plurality of first channels.

8. The electrical connector of claim 7, wherein:
each of the plurality of first channels comprises a first sidewall and a second sidewall opposite to each other, and a first groove and a second groove recessed into the housing from the first sidewall and the second sidewall, respectively; and
for each of the plurality of first beams, the first subportion comprises a first side edge and a second side edge opposite to each other, the first side edge and the second side edge of the first subportion are received in the first groove and the second groove of the respective first channel, respectively.

9. The electrical connector of claim 8, wherein, for each of the plurality of first beams:
the first subportion further comprises a first barb and a second barb protruding from the first side edge and the second side edge, respectively, and
the first barb and the second barb engage with a bottom wall of the first groove and a bottom wall of the second groove of the respective first channel, respectively.

10. The electrical connector of claim 9, wherein:
each of the plurality of first channels comprises a third sidewall and a fourth sidewall opposite to each other;
the third sidewall comprises an opening connected to the intermediate portion of the respective ground terminal; and
the first subportion of each of the plurality of first beams and the second beam is disposed against the fourth sidewall of the respective first channel.

11. The electrical connector of claim 1, wherein:
the conductive member is a first conductive member;
the electrical connector further comprises a second conductive member disposed in the housing, the second conductive member separated from the first row by the first conductive member; and
the second conductive member electrically couples the ground terminals in the first row.

12. The electrical connector of claim 11, wherein the second conductive member comprises:
a planar body orthogonal to the planar body of the first conductive member; and
a plurality of beams extending from the planar body towards respective ground terminals in the first row.

13. The electrical connector of claim 12, wherein, for the second conductive member:
each of the plurality of beams comprises a connecting subportion and a contact subportion;
the connecting subportion extends from an edge of the planar body towards a respective ground terminal in the first row; and
the contact subportion extends from the connecting subportion and configured to contact the intermediate portion of the respective ground terminal in the first row.

14. The electrical connector of claim 13, wherein, for each ground terminal in the first row:
the first conductive member and the second conductive member contact a same subportion of the intermediate portion of the respective ground terminal in the first row from opposite sides.

15. An electrical connector comprising:
a housing comprising a mating face, a mounting face, and a slot recessed from the mating face;
a plurality of conductive elements held by the housing in first and second rows separated by the slot, each of the plurality of conductive elements comprising a mating end curving into the slot, a tail end extending out of the mounting face, and an intermediate portion between the mating end and the tail end, the plurality of conductive elements disposed in the housing, with the tail ends at least partially located outside of the housing; and
a conductive member separated from the slot by the first row of conductive element, the conductive member comprising:
a planar body disposed in the housing and orthogonal to the mating face, and
a plurality of beams extending from the planar body and coupled to the intermediate portions of a subset of the plurality of conductive elements in the first row.

16. The electrical connector of claim 15, wherein:
the planar body of the conductive member extends in parallel to the first row of conductive element; and
each of the plurality of beams comprises:
a first subportion extending from a bottom edge of the planar body towards a respective conductive element of the subset of the plurality of conductive elements in the first row, and
a second subportion extending from the first subportion and parallel to a subportion of the intermediate portion of the respective conductive element in the first row.

17. The electrical connector of claim 16, wherein:
the housing comprises an elongated groove spaced from the mounting face and a plurality of channels connected to the groove;
the subportion of the intermediate portion of each conductive element of the subset of the plurality of conductive elements in the first row is disposed in a respective one of the plurality of channels;
the planar body of the conductive member disposed in the elongated groove; and
each of the plurality of beams of the conductive member is disposed in a respective one of the plurality of channels.

18. An electrical connector comprising:
a plurality of conductive elements disposed in a row, each of the plurality of conductive elements comprising a mating end having a mating contact portion, a tail end configured to mount to a contact pad on a surface of a circuit board, and an intermediate portion between the mating end and the tail end;
a first conductive member disposed on a first side of the row, the first conductive member comprising a plurality of first beams configured to contact the intermediate portion of selected ones of the plurality of conductive elements from the first side; and
a second conductive member disposed on a second side of the row opposite the first side, the second conductive member comprising a plurality of second beams configured to contact the intermediate portions of the selected ones of the plurality of conductive elements from the second side.

19. The electrical connector of claim 18, wherein:
each of the first and second conductive members comprises a planar body; and
the planar body of the first and second conductive members extending orthogonally to each other.

20. The electrical connector of claim 19, wherein:
the first conductive member comprises a plurality of beams configured to press against the intermediate portions of the respective ones of the selected conductive elements; and
the second conductive member comprises a plurality of beams configured to be welded to the intermediate portions of the respective ones of the selected conductive elements.
